(19) United States
(12) Patent Application Publication
(10) Pub. No.: US 2009/0207245 A1
(43) Pub. Date: Aug. 20, 2009

(54) DISK INSPECTION APPARATUS AND METHOD

(75) Inventors: Yoichi Hayashi, Odawara-Shi (JP); Shinichiro Okada, Odawara-Shi (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/343,918

(22) Filed: Dec. 24, 2008

(30) Foreign Application Priority Data
Dec. 27, 2007 (JP) 2007-337561
Aug. 29, 2008 (JP) 2008-222166

(51) Int. Cl. H04N 7/18

(52) U.S. Cl. 348/92; 348/E07.085

(57) ABSTRACT

A disk inspection apparatus according to the present invention comprises: a disk holding device which holds a disk; an illumination device which radiates an inspection area portion having a predetermined shape on a disk surface including an edge of the disk held by the disk holding device, with illumination light having an illumination light pattern which forms a range of delivery of illumination light having approximately the same shape as that of the inspection area; and an imaging device which includes, in the field of view, the inspection area portion on the disk surface including the edge illuminated by the illumination device, and takes an image of light reflected from the inspection area portion.

### BACKGROUND OF THE INVENTION

1. Field of the Invention

The present invention relates to a disk inspection apparatus and method, and in particular to a disk inspection method and apparatus suitable for inspecting contamination conditions of surfaces and end surfaces of a magnetic disk, an optical disk, a magnetic optical disk and the like used for a hard disk drive.

2. Description of the Related Art

Recently, a hard disk drive has had a denser recording density, and a head floating height has become immensely small. Accordingly, even a fine particle may cause a dropout, and there also may be increasing chances for a particle to bite into a head to damage data. In addition, movement of a particle on not only a recording surface but also an outer and inner circumference surfaces may cause the failure as described above. Especially an edge portion cannot avoid contact with a carrying case, a handling jig, a chuck in a facility and the like, and may constitute a source of particles due to having a corner, and particles can easily move to tend to provide a source of failures.

Further, in the magnetic transfer technology in which information such as a servo signal is preliminarily written in a magnetic disk, it is necessary for a master disk (transfer master disk) to closely attach to a slave disk (magnetic disk receiving transfer), and dust between the disks may cause transfer failure. The dust may include dust which was generated at manufacturing or transporting a slave disk, and attached to the slave disk to be brought in. Preferably, the dust attached to a disk and brought in, as described above, may be checked for the existence thereof before a transfer process, and the disk having dust attached thereto may be rejected.

A magnetic disk used for a hard disk drive, conventionally, has been inspected for a defect of surfaces and the existence of a particle attached thereto during manufacturing process stages, and there have been an inspection apparatus using laser beams disclosed in Japanese Patent Application Laid-Open No. 2000-9453 and an inspection apparatus using an imaging camera of charge-coupled devices (CCD) and the like disclosed in Japanese Patent Applications Laid-Open No. 2000-162146 and No. H06-148088, in practical use.

### SUMMARY OF THE INVENTION

However, JP-A-2000-9453 describes the inspection machine dedicated to an end surface which was designed to inspect only an outer circumference end surface (edge) of a hard disk, and the apparatus disclosed in JP-A-2000-9453 cannot inspect a surface and an inner circumference end surface of a disk. For inspection of the surface and the inner circumference end surface (edge), a separate inspection apparatus is needed, respectively. Also, the technology described in JP-A-2000-9453 relates to measurement of a strength in the direct direction of laser beams with which a disk end surface is radiated, and to measurement of a strength of diffusive reflection from an inner surface of a divided reflector, and accordingly it is difficult to verify the measurement result because separation between a defect having a small effect, such as a scratch on a disk end surface, and dust (the dust having a large effect) is inadequately provided from the measured information, and measurement principles of the technology, further, is not intended to provide an image reflecting an edge portion.

On the other hand, the inspection apparatus disclosed in JP-A-2000-162146 and JP-A-H06-148088 is intended to inspect only a flat portion of one surface of a disk (on a recording surface), and cannot inspect an edge or a portion near the edge.

Any of the apparatuses disclosed in JP-A-2000-9453, JP-A-2000-162146 and JP-A-H06-148088 cannot simultaneously inspect a surface and an edge portion of a disk, and a single apparatus cannot simultaneously inspect both surfaces and an end surface of a disk. Granted that inspection of both surfaces are achieved, it is necessary to combine two or more apparatuses and to turn around a disk to inspect the back face, and a facility, accordingly, has to be made expensive and large, requiring an installation site. Also, because inspection of each disk is repeated by handling each time, handling of the disk may generate a particle, thereby quality may be degraded and there may be many issues concerning throughput.

The present invention has been made in view of the circumstances, and an object thereof is to provide a disk inspection apparatus and a method suitable for simultaneous inspection of a surface (a recording surface portion) and an end surface (an edge portion) of a disk, and simultaneous inspection of both surfaces.

To achieve the object described above, a disk inspection apparatus according to the present invention comprises: a disk holding device which holds a disk; an illumination device which radiates an inspection area portion having a predetermined shape on a disk surface including an edge of the disk held by the disk holding device, with illumination light having an illumination light pattern which forms a range of delivery of illumination light having approximately the same shape as that of the inspection area; and an imaging device which includes, in the field of view, the inspection area portion on the disk surface including the edge illuminated by the illumination device, and takes an image of light reflected from the inspection area portion.

The present invention allows a flat portion and an edge portion of a disk to be simultaneously inspected. Particularly, the illumination device of the present invention allows for illumination in a necessary and sufficient range, and prevention of abnormal reflection and blooming in the edge portion, further preventing an undesired image from showing up because of pattern illumination in the range of delivery of illumination light approximately coincided with a shape of the inspection area.

According to an aspect of the present invention, a disk inspection apparatus is provided in which the disk has texture formed on the disk surface, and the illumination device radiates illumination light along a tangential direction of the texture.

The illumination from the direction of the texture allows diffuse reflection due to irregularity of the texture to be prevented.

According to another aspect of the present invention, a disk inspection apparatus is provided in which the illumination device includes a light guide, and illumination light is radiated from an end surface of the light guide.

Use of the light guide such as an optical fiber and a projection lens mounted on its end allows illumination light to be formed in a shape of a desired radiation pattern.

According to another aspect of the present invention, a disk inspection apparatus is provided in which the illumination device includes a plurality of optical projection portions which can illuminate the inspection area on the same disk surface, and the plurality of optical projection portions radiates the disk surface including the edge from a plurality of directions with illumination light.

In such an aspect, the plurality of optical projection portions, further, symmetrically radiates the disk surface with illumination light.

An aspect in which the illumination device composed of a set (pair) of two optical projection portions is configured to symmetrically illuminate from two directions to form a predetermined illumination light pattern on the disk surface allows a light amount distribution in a radiation area to be unformed.

Further, according to another aspect of the present invention, a disk inspection apparatus is provided in which the disk is a circular disk having a hole formed in the central portion, and the plurality of optical projection portions radiates the edge portion of the disk from the direction along the circumferential direction of the disk with illumination light.

Illumination of the edge portion of the disk from a plurality of directions along the circumferential direction of the disk allows for taking a good image of a chamfer portion of the edge.

Also, according to another aspect of the present invention, a disk inspection apparatus is provided in which the disk is a circular disk having a hole formed in the central portion, and the inspection area portion has a sector shape including an inner circumference edge and an outer circumference edge.

For example, an inspection area (inspection window) is formed in a sector shape by dividing the circular disk equally by “n” along the circumferential direction, thereby the entire disk surfaces can be inspected by taking images of each of both surfaces “n” times.

According to another aspect of the present invention, a disk inspection apparatus is provided in which the disk holding device includes a disk rotation device which rotates the disk held in a vertical attitude, and rotation of the disk by the disk rotation device allows a portion of the disk surface at different positions to be inspected.

According to another aspect of the present invention, a disk inspection apparatus is provided in which the disk holding device holds the disk in a vertical attitude.

Holding the disk in the vertical attitude allows simultaneous inspection of both surfaces to be facilitated, and also a particle to be prevented from attaching due to the gravity. Further, a down flow of clean air is not disturbed, so that cleanliness around the disk can be maintained.

A disk inspection apparatus according to another aspect of the present invention comprises: as the illumination device, a first illumination device which radiates an inspection area portion having a predetermined shape including an edge of a first surface, namely one surface of a disk held by the disk holding device, with illumination light having an illumination light pattern which forms a range of delivery of illumination light having approximately the same shape as that of the inspection area, and a second illumination device which radiates an inspection area portion having a predetermined shape including an edge of a second surface, namely the other surface of the disk held by the disk holding device, with illumination light having an illumination light pattern which forms a range of delivery of illumination light having approximately the same shape as that of the inspection area; and, as the imaging device, a first imaging device which includes, in the field of view, the inspection area portion on the first surface illuminated by the first illumination device, and takes an image of light reflected from the inspection area portion, and a second imaging device which includes, in the field of view, the inspection area portion on the second surface illuminated by the second illumination device, and takes an image of light reflected from the inspection area portion.

Such an aspect allows a flat portion and an edge portion of both surfaces of the disk to be simultaneously inspected without the disk being handled (inverted).

In this aspect, further, provided is a disk inspection apparatus further comprising a control device which controls to obtain an inspection image of all both surfaces of one disk by taking images multiple times by each of the first and second imaging devices while changing positions of the disk to be inspected by rotation by the disk rotation device.

Also, according to further another aspect of the present invention, a disk inspection apparatus is provided in which taking an image by the first imaging device and taking an image by the second imaging device are alternately performed.

Simultaneously taking images of both surfaces of the first and second surfaces can be provided (at the same timing), but a preferred aspect may be that taking an image of each surface is alternately performed in consideration of operation of taking an image, transfer of image data, and a data processing time. Such an aspect allows a processing burden to be distributed to a processing (computing) apparatus.

According to an aspect of the present invention, a disk inspection apparatus is provided in which the disk is a magnetic disk having a magnetic layer for magnetic recording.

For example, dust attached to not only a recording surface but also an edge portion presents a problem because a magnetic recording medium used for a hard disk drive has to tightly contact a master carrier at a reduced pressure in a magnetic transfer process stage. The disk inspection apparatus of the present invention is suitable as a device which inspects a slave medium for dust attached thereto before the magnetic transfer process stage because it can simultaneously inspect the recording surface and the edge portion.

According to another aspect of the present invention, provided is a disk inspection apparatus further comprising an image processing device which detects a plurality of edge points of the disk in an image obtained by the imaging device from the image, computes a center position and a radius of the disk, and from the computational result, forms a window for each inspection surface.

There may be an aspect in which an image processing device (first image processing device) which processes the image obtained by the first imaging device and an image processing device (second image processing device) which processes the image obtained by the second imaging device are separately provided, respectively. Also, there may be an aspect in which one image processing apparatus processes both images.

According to another aspect of the present invention, provided is a disk inspection apparatus further comprising an image analysis device which recognizes a reflection shape of the edge portion of the disk from the image obtained by the imaging device, and judges whether the reflection shape is generated by dust or by factors except the dust, based on the reflection shape.

In the edge portion of the disk, it is expected that reflection is generated by factors such as a scratch caused by a chuck and a deposition defect, except the attachment of dust (particle). An image analysis process is preferably performed that separates between reflection generated by dust and reflection generated by factors except the dust from the taken image to detect.

According to another aspect of the present invention, provided is a disk inspection apparatus further comprising a dust detection processing device which detects dust attached to a flat portion of a disk and dust attached to an edge portion of the disk from the image obtained by the imaging device.

As already described above, preferably, a detection process of dust on the flat portion and a detection process of dust on the edge portion are performed using a separate algorithm suitable for each process because the edge portion has more factors for reflection compared to the flat portion, and an allowable attachment quantity of dust is different from each other.

In addition, functions for processing and analyzing the image obtained by the imaging device can be achieved by a program (software), and a computer on which the program is installed can be used as the image processing device, the image analysis device and the dust detection processing device.

According to another aspect of the present invention, a disk inspection apparatus is provided in which an incident angle of illumination light provided by the illumination device relative to the disk surface is not smaller than 60° and less than 90°.

Projecting light beams with a shallow angle not larger than 30° to an inspection surface (disk surface) allows only a defect to be brightened. In addition, a too large angle formed between the disk surface and an incident optical axis (if the incident angle of the light beams is less than 60° relative to the disk surface) presents problems that an undesired image of the illumination device shows up, and reflected light directly enters the imaging device. Further, when the incident angle is not smaller than 90°, the illumination light is “kicked out” by an inspection target (disk) to form a shadow.

According to further another aspect of the present invention, a disk inspection apparatus is provided in which the illumination device is configured by bundling optical fibers, and on an exit end of the optical fibers, a lens is provided to radiate the disk surface with defocused light. Such an aspect provides an advantage of reducing non-uniformity of the bundled fibers.

According to another aspect of the present invention, a disk inspection apparatus is provided in which a position at which illumination light is radiated by the illumination device is aligned so that a range of delivery of the illumination light becomes larger than the inspection area portion.

Because an amount of light drops in a boundary portion (peripheral portion) of the range of delivery of the illumination light, the inspection area portion to be inspected is preferably radiated with a central area except such boundary portion (the area where the amount of light is stable).

According to another aspect of the present invention, a disk inspection apparatus is provided in which, when alternately taking an image to inspect as described above, illumination on the side not being inspected is extinguished or blocked.

When both surfaces of the disk are alternately inspected, illumination on the side not being inspected is preferably extinguished or blocked by a shutter or the like so that the illumination light on the side not being inspected does not affect the side being inspected as a noise.

Further, the present invention provides a method invention for achieving the object described above. That is, the disk inspection method according to the present invention comprises the steps of: radiating, after holding a disk to be inspected, an inspection area portion having a predetermined shape on a disk surface including an edge of the disk held, with illumination light having an illumination light pattern which forms a range of delivery of illumination light having approximately the same shape as that of the inspection area; taking an image of light reflected from the inspection area portion by an imaging device which includes, in the field of view, the inspection area portion on the disk surface including the edge illuminated by the step of illuminating; and analyzing the image obtained by the step of taking an image.

According to the present invention, concerning a disk to be inspected, a flat portion and an edge portion of the disk can be simultaneously inspected by obtaining a taken image of the disk surface including the edge, and an inspection time also can be reduced.

### BRIEF DESCRIPTION OF THE DRAWINGS

Now, preferred embodiments of the present invention will be hereinafter described in detail with respect to the accompanying drawings, wherein:

FIG. 1 is a perspective view of a chuck apparatus according to an embodiment of the present invention;

FIG. 2 is a side view of the chuck apparatus shown in FIG. 1;

FIG. 3 is an enlarged view of a main portion showing a drive mechanism of a movable claw;

FIG. 4 is a back elevation view of the chuck apparatus shown in FIG. 1;

FIG. 5 is a perspective view of a chuck body;

FIG. 6 is an enlarged view of a movable claw portion at chucking;

FIG. 7 shows another exemplary form of a groove formed in an outer circumference surface of a claw;

FIG. 8 is a view seen from the arrow B in FIG. 5;

FIG. 9 is a cross-section view showing conditions in which a disk is chucked;

FIG. 10 is a perspective view showing an exemplary configuration of a disk inspection apparatus

FIG. 11 is a side view of the disk inspection apparatus shown in FIG. 10;

FIG. 12 is a plan view of the disk inspection apparatus shown in FIG. 10;

FIGS. 13A and 13B are illustrations of an illumination apparatus used for the disk inspection apparatus;

FIG. 14 shows a luminance distribution of an illumination light pattern;

FIG. 15 is an illustration used for describing an illumination method for an edge portion of a disk;

FIG. 16 is a block diagram of an inspection system including the disk inspection apparatus;

FIG. 17 is a processing block diagram showing a process flow performed by the inspection system of an embodiment;

FIG. 18 is an illustration showing computation of an outer circumferential, circular line from an inspection image;

FIG. 19 is an enlarged, side view of an outer circumference portion of a disk;

FIG. 20 shows an exemplary window image processed for image emphasis;

FIG. 21 shows exemplary division of a processing window for each area in an inspection image;

FIG. 22 shows an exemplary image (corresponding to one inspection image) of the measurement result;

FIG. 23 shows an exemplary image (one entire surface of a disk) of the measurement result;

FIG. 24 is a flow chart showing exemplary control of the inspection system;

FIG. 25 is a flow chart showing processing procedures for automatic inspection;

FIG. 26 is a flow chart showing processing procedures for automatic inspection;

FIG. 27 is a flow chart showing processing procedures for disk inspection according to an embodiment;

FIG. 28 is a plan view showing an exemplary configuration of an illumination optical system;

FIG. 29 is a perspective view showing an exemplary configuration of optical fibers cable having a branch form;

FIG. 30 is an enlarged view of an exit end surface of the optical fibers cable shown in FIG. 29;

FIG. 31 shows a periphery of an optical projection portion of the illumination apparatus, seen from the front side directly facing a disk surface;

FIG. 32 is a plan view of FIG. 31;

FIG. 33 shows the relation between a sector-shaped inspection area and a range of delivery of defocused illumination light having a radiation pattern;

FIG. 34 is a graph showing a luminance distribution along the line A-A in FIG. 33;

FIG. 35 is an illustration of an optical axis of illumination light parallel to the direction of texture; and

FIG. 36 shows a configuration of a light source apparatus incorporating a shutter.

### DETAILED DESCRIPTION OF THE PREFERRED EMBODIMENTS

First, there will be description of a configuration for a chuck apparatus of a disk used for a disk inspection apparatus according to an embodiment of the present invention. In addition, in this embodiment, a disk inspection apparatus and a chuck apparatus of a magnetic disk used for a hard disk drive, by way of example, will be described.

### [Exemplary Configuration of Chuck Apparatus of Disk]

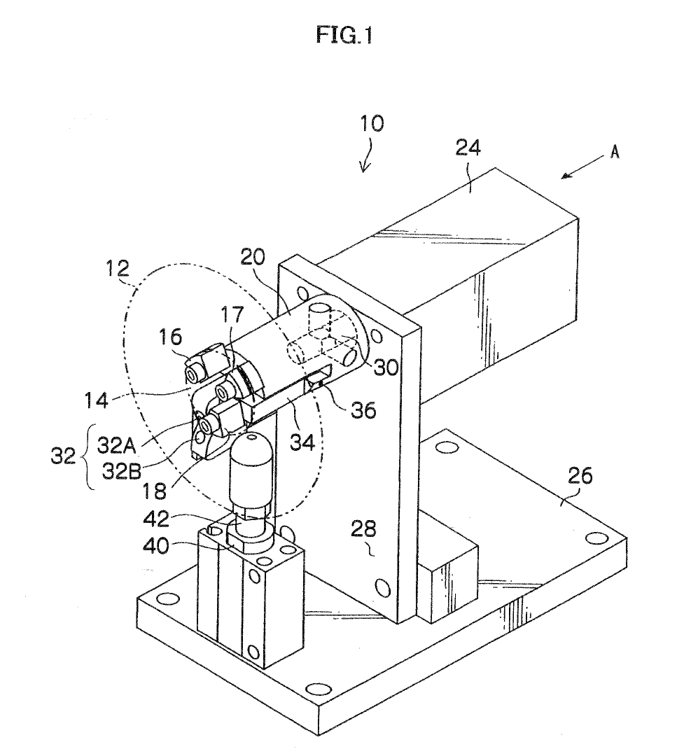

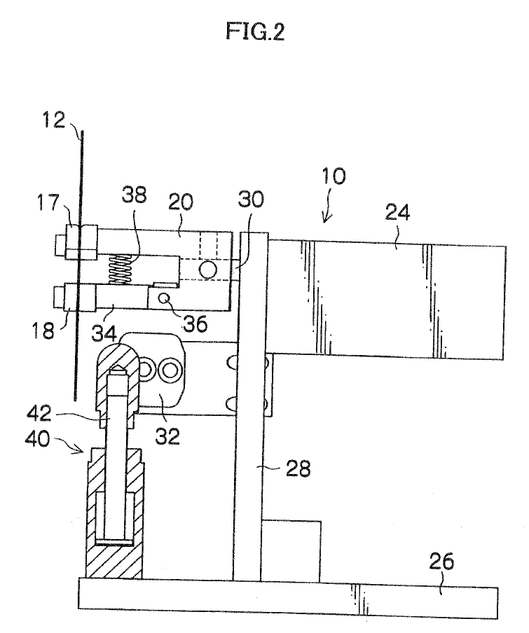

FIG. 1 is a perspective view showing an exemplary configuration of a chuck apparatus of a disk used for a disk inspection apparatus according to an embodiment of the present invention. FIG. 2 is a side view of FIG. 1. As shown in these drawings, a chuck apparatus 10 according to this embodiment includes: a chuck body 20 having three claws 16, 17, 18 brought in contact with a circumference edge of a hole 14 (inner circumference surface of a disk 12) formed in the central portion of the disk 12; and a motor 24 for rotating the chuck body 20.

The motor 24 is fixed to a support plate 28 standing vertically on a base plate 26, and its axis of rotation (spindle 30) is disposed in the horizontal direction (the direction perpendicular to the gravity direction). The chuck body 20 mounted on an end of the spindle 30 holds, by the three claws 16, 17, 18, the disk 12 in a vertical attitude (the disk surface takes an attitude parallel to the gravity direction).

On the support plate 28, a contactless distance sensor 32 is mounted, and it detects a position of the surface of the disk 12. Whether the disk 12 is held at a right position (in a right attitude) or not can be judged based on a detection signal of the distance sensor 32. In addition, this embodiment employs the optical distance sensor 32 having an optical projection portion 32A for radiating laser beams and an optical receiving portion 32B for receiving light reflected from a measurement target, but not limited to an optical sensor, a sensor of other type such as an ultrasonic type may be used.

Fixed claws are two claws designated by the reference numerals 16, 17 of the three claws provided in the chuck body 20 (two claws arranged laterally side-by-side at the top in FIG. 1) and a movable claw is the claw left and designated by the reference numeral 18 (the claw arranged at the bottom in FIG. 1). The claws designated by the reference numerals 16, 17, and the claw designated by the reference numeral 18 may be hereinafter called “fixed claw” and “movable claw”, respectively.

A base portion of an arm 34 of the movable claw 18 is mounted to the chuck body 20 through a pivotal axis 36. The arm 34 of the movable claw 18 is biased downwards in FIG. 2 (to the direction in which the movable claw 18 is extended in the radial direction of the hole 14) by a spring member 38 (corresponding to a “biasing device”, in this embodiment, a compression coil spring has been used, but a magnetic spring, a pneumatic spring, a leaf spring and the like may be used), and with an external force not applied, the movable claw 18 is held approximately in the horizontal direction similarly to the fixed claws 16, 17. The movable claw 18, actually, is slightly inclined because of need of a chuck allowance, and inclined by the distance of about 0.1 mm to 0.5 mm from the horizontal position.

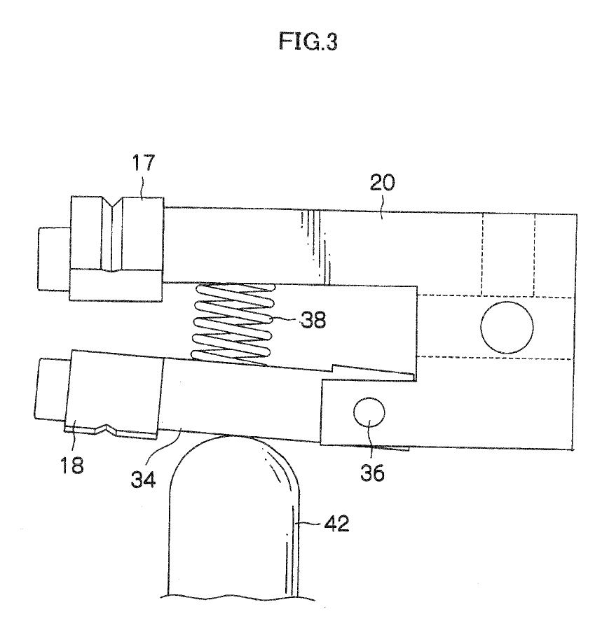

Below the arm 34 of the movable claw 18, a cylinder 40 (corresponding to a “claw drive device”) is disposed as a device which pushes up the movable claw 18. Extension of a rod 42 of the cylinder 40 can push up the arm 34 of the movable claw 18 upwards against biasing force of the spring member 38 (see FIG. 3). At this condition, contraction of the rod 42 returns the movable claw 18 to the original, horizontal position by restoring force of the spring member 38. The drive device which moves the movable claw 18 against the biasing force of the spring member 38, not limited to the cylinder 40, may be another device such as an actuator and a compressed air.

Because a portion of the pivotal axis 36 for swingably supporting the movable claw 18 (corresponding to a “slide portion of a movable mechanism”) is a slide portion where members contact with each other, such a slide portion is preferably configured to be disposed at a position far away from the disk 12, in consideration of generation of a particle due to sliding between members. As a guide line for design, the slide portion is preferably disposed at a position away from the disk 12 by a distance not shorter than the distance of “the radius of the outer circumference—the radius of the inner circumference” of the disk 12, and more preferably not smaller than the radius of the outer circumference.

In this embodiment, the movable claw 18 has been moved in a swinging manner through arcuate motion centered on the pivotal axis 36, but the mechanism for moving the movable claw 18 is not limited to that in this embodiment, and for example, a mechanism for moving the movable claw through linear motion may be used.

However, the mechanism through the linear motion may have a large slide portion and become complex compared to the mechanism through the arcuate motion, and if position accuracy is not constrained, the mechanism through the arcuate motion as in this embodiment may have a simpler structure and more easily control generation of particles.

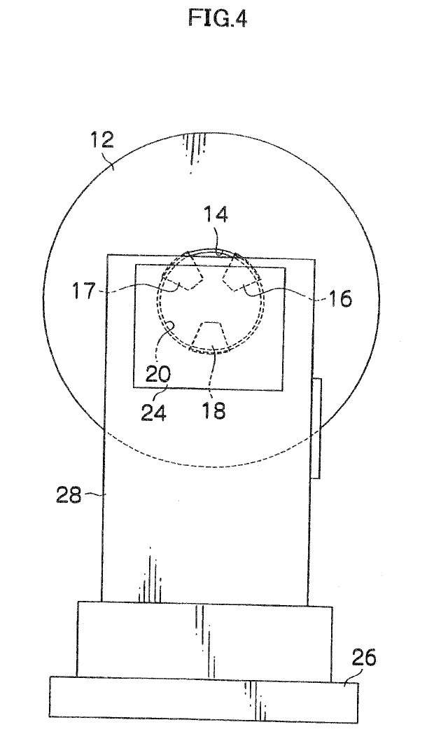

FIG. 4 is a back elevation view of the chuck apparatus 10 (seen from the arrow A in FIG. 1). An outer diameter of the chuck body 20 is not larger than the diameter of the hole 14 of the disk 12 (preferably, smaller than the diameter of the hole), and three claws 16, 17, 18 are disposed to be contained inside the diameter of the hole of the disk 12 as far as possible.

Further, a height of an upper end surface of the support plate 28 is set equal to or lower than the height of the chuck body 20 (see FIG. 2), and the motor 24 fixed on the support plate 28, also, is configured not to be higher than the upper end surface of the support plate 28. Such configuration may be achieved by shifting the motor axis using a gear or a pulley, or using a motor having a small diameter.

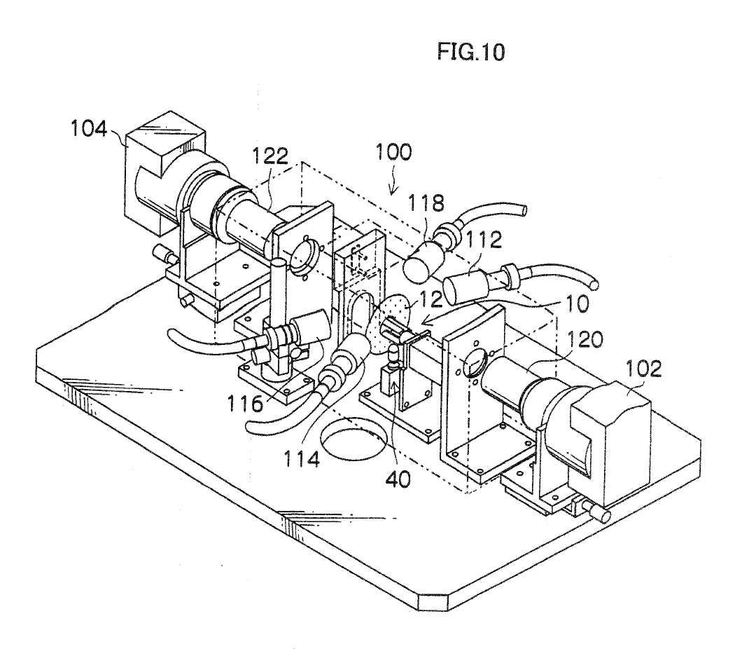

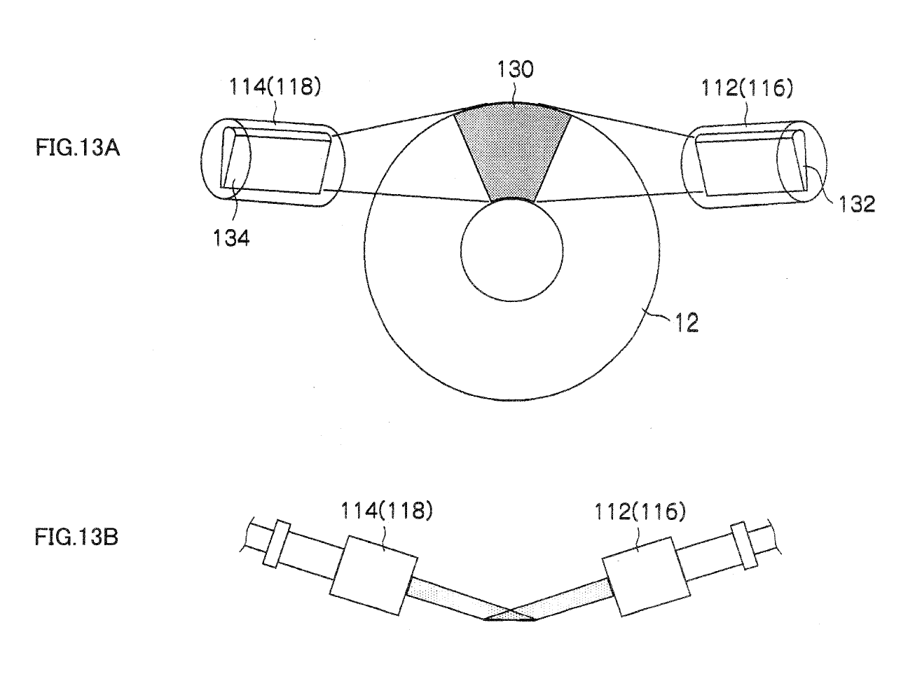

Such configuration, as shown in FIG. 4, allows approximately the entire region of a portion of both surfaces of the disk 12 in the radial direction (an upper region in FIG. 4) to be observed without any obstacle, seen from the direction perpendicular to a recording surface of the chucked disk 12. In addition, in this embodiment, in a disk inspection apparatus described below (FIG. 10), an area including at least a recording surface area (designated by the reference numeral 130 in FIG. 13) in a predetermined range of angle (α=45°) constituting an inspection range can be observed without any obstacle. Accordingly, both surfaces can be simultaneously inspected by the disk inspection apparatus, and an area very close to an inner circumstance edge of the disk can be inspected.

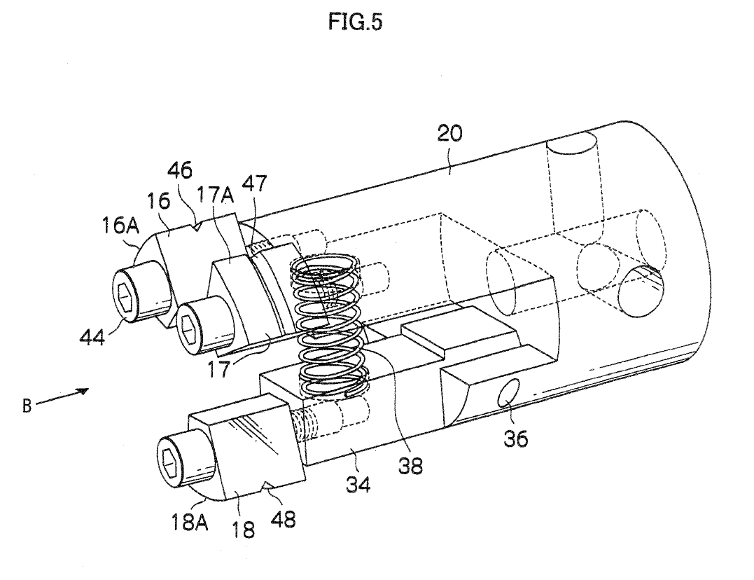

FIG. 5 is a perspective view of a main portion of the chuck apparatus 10. As shown, each of the claws 16, 17, 18 is made of material different from the chuck body 20 as a separate member, and fixed to the chuck body 20 by a bolt 44.

For claw material used for the fixed claws 16, 17 and the movable claw 18, polybenzimidazole (PBI) is suitable. Polybenzimidazole has a high abrasion resistance and sliding property especially against a glass disk, and hardly generates any particle. Also, it has a low reflectance characteristic without any addition, and an advantage that it can avoid an effect on a particle adhesion inspection (optical inspection using a high illumination intensity) described below. There is a method that carbon is added to resin to achieve a low reflectance characteristic, but use of material without any addition is preferable in view of controlling particles.

Each of the claws 16, 17, 18 is preferably configured in a form to contact only the inner circumference surface of the hole of the disk 12 at being chucked, and not to contact a flat plane of the disk (recording surface). The claws 16, 17, 18 in this embodiment have outer circumference surfaces 16A, 17A, 18A in a partially arcuate shape along the inner circumference of the hole of the disk 12, respectively, and in the outer circumference surfaces 16A, 17A, 18A in an arcuate shape of the claws 16, 17, 18, grooves 46, 47, 48, each abutting on the circumference edge of the hole 14 of the disk 12, are formed, respectively. The grooves 46, 47, 48 constrain a holding position and attitude of the disk 12.

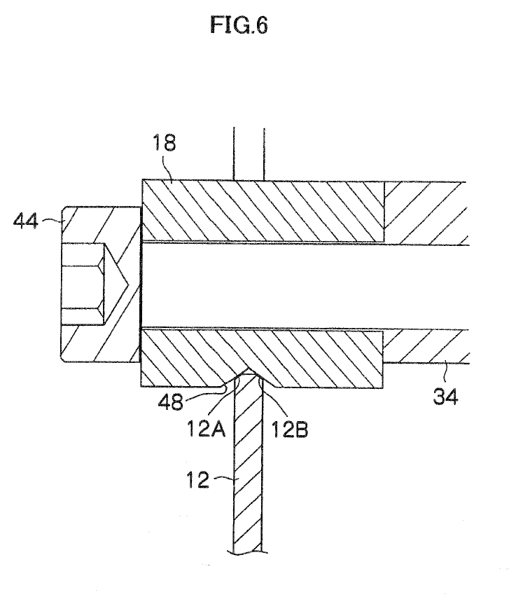

FIG. 6 is an enlarged view of the groove 48 formed in the movable claw 18. In addition, the grooves 46, 47 formed in the fixed claws are similar to it, and the groove 48 of the movable claw 18 shown in FIG. 6 will be described representatively.

As shown, the groove 48 has a V-shape in its cross section. An angle made between such V-shaped ramps coincides with an angle of chamfer of the inner circumference edge of the disk 12, and at chucking, chambered surfaces 12A, 12B of the inner circumference edge of the disk 12 contact the groove 48, and the biasing force of the spring member 38 presses the claw 18 against the disk 12 to hold. In FIG. 6, for illustration purpose, the deep groove 48 is depicted, but a too deep groove 48 increases a portion where a flat portion of the disk (area of the recording surface) is covered by the groove (area where inspection cannot be conducted), and accordingly the groove 48 is preferably as shallow as possible.

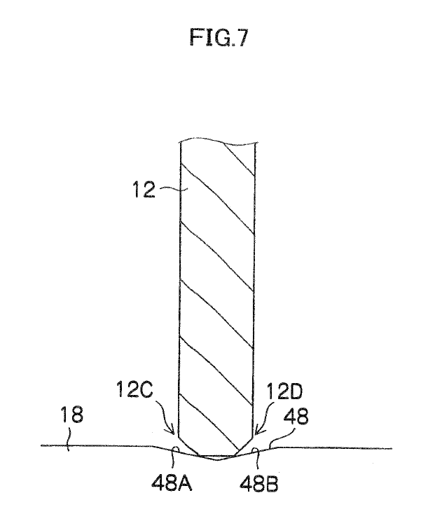

Further, the form of the groove 48 is not limited to that shown in FIG. 6, and for example, as shown in FIG. 7, a form having a very shallow groove is also preferable in which angles of tilt of ramps of the groove 48 are set to be very small so that a spread angle formed between opposite ramps 48A, 48B is made large. Such form allows even corners (the reference characters 12C, 12D) of the recording surface of the disk 12 to be inspected, so that the corner 12C can be inspected for the attachment of dust thereto.

In addition, if the positioning accuracy of disk handling by a handling robot (not shown) is improved, the groove 48 may be omitted.

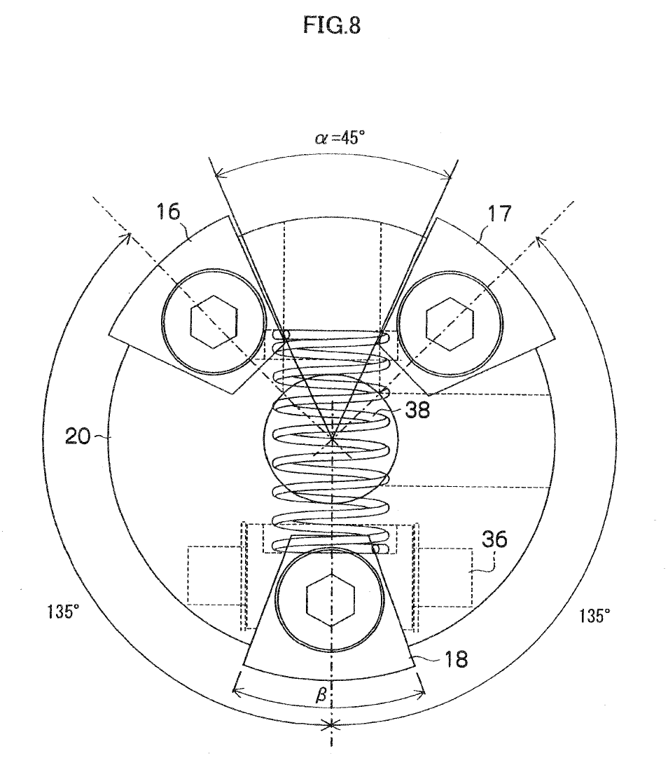

FIG. 8 is an elevation view of the chuck body 20 (the view seen from the arrow B in FIG. 5). The positional relation between the fixed claws 16, 17 and the movable claw 18 is as shown in FIG. 8. That is, the three claws 16, 17, 18 are disposed on the same circumference having the original point that is the center of the spindle 30, and the movable claw 18 is disposed at the bottom in FIG. 8 (at 6 o'clock position), and the fixed claw 17 is disposed at a position rotated counterclockwise from the movable claw 18 by 135°, and the fixed claw 16 is disposed at a position rotated clockwise from the movable claw 18 by 135°.

That is, an angle θ1 formed between the positions of two fixed claws 16, 17, seen from the center of the spindle 30 is 90°, and an angle θ2 formed between the position of the movable claw 18 and the position of the fixed claw 16 (or 17), seen from the center is 135°. In addition, θ1<θ2 is preferable in consideration of stability at mounting the disk and the like.

The arrangement of the claws like that of the embodiment is suitable when a single disk 12 is divided into 8 sectors by 45°, and the entire range of the disk surface is inspected by a disk inspection apparatus described below through inspection of each of the 8 sectors, and also, the arrangement has an advantage that the disk 12 in the vertical attitude can be stably held.

On the flat plane seen from the arrow B in FIG. 8, each of the claws 16, 17, 18 is formed in an approximate sector shape. An angle β formed by an arc of each claw 16, 17, 18 (arc on the outer circumference surface) relative to the center is preferably set to an angle slightly smaller (43°, in this embodiment) than an angle α defining a range of one inspection (α=45°, in this embodiment). However, the arrangement of the fixed claws 16, 17 and the movable claw 18, and the angle formed by the arc of each claw 16, 17, 18 relative to the center are not limited to this embodiment, and these may be determined in view of the angle α defining the range of one inspection in the disk inspection apparatus and the stability in holding the disk.

Further, in this embodiment, the arrangement of two fixed claws 16, 17 and one movable claw 18 is illustrated, but the number and arrangement of claws, a ratio and balance of arrangement of movable claws and fixed claws may take various forms.

Operation of the chuck apparatus 10 configured as described above at chucking a disk 12 is as follows.

The disk 12 is handled by a handling robot not shown. The handling robot grasps the disk 12 by a plurality of claws, and carries the disk 12 to the chuck apparatus 10.

A holding mechanism of the disk 12 in the handling robot is not specifically limited, and for example, it may be configured by using a claw structure similar to the chuck apparatus 10 of the embodiment (two fixed claws and one movable claw) in an outer circumference chuck, to support an outer circumference of the disk 12 by the three claws. In addition, the chuck apparatus 10 of the embodiment is an inner circumference chucking system, and for the handling robot, it may be convenient to use an outer circumference chucking system, but there may be an aspect in which the inner circumference chucking system is also used for the handling robot, and using a gap between the claws 16, 17, 18 of the chuck apparatus 10, the disk 12 is carried and received.

To synchronize timing between carrying operation of the disk 12 by the handling robot and operation of the cylinder 40 in the chuck apparatus 10, the robot is preferably configured to control the cylinder 40. That is, a control apparatus for controlling the handling robot is configured to control the cylinder 40. When the disk 12 is mounted on the chuck apparatus 10, first, the rod 42 of the cylinder 40 is extended to press up the movable claw 18 (see FIG. 3).

In such conditions, the handling robot comes near along with the disk 12, aligns the hole 14 of the disk 12 with the claws 16, 17, 18, and moves the disk 12 so that the claws 16, 17, 18 are inserted into the hole itself 14. After the disk 12 is moved to the positions of the grooves 46, 47, the disk 12 is slightly moved downwards, and stopped immediately before the inner circumference surface of the disk contacts the fixed claws 16, 17 (by a distance not larger than 0.1 mm). At this time, the chuck of the handling robot is released, the disk 12, then, reasonably contacts the fixed claws 16, 17 due to the own weight.

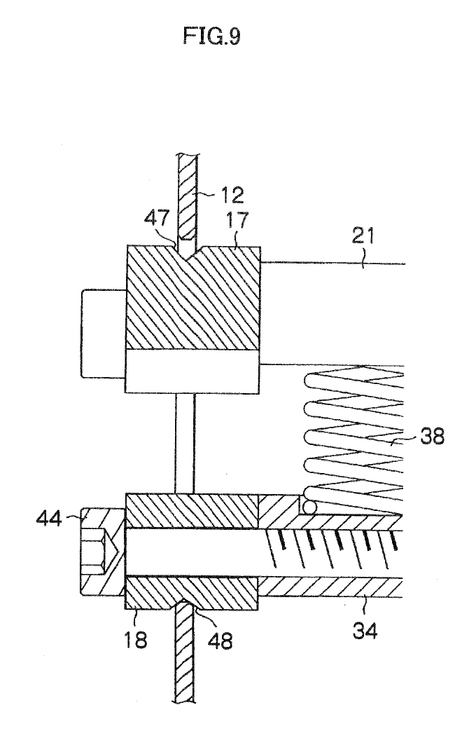

Subsequently, the rod 42 of the cylinder 40 is slowly contracted to move the movable claw 18 downwards by the force of the spring member 38, and the movable claw 18 is, then, brought into contact with the inner circumference of the disk 12. In such a manner, release of the external force of the rod 42 and the biasing force of the spring member 38 cause the claws 16, 17, 18 to contact the inner circumference of the disk 12 with a pressure being applied, thereby the disk 12 is stably held. FIG. 9 is a cross-section view of a main portion showing conditions in which the disk is chucked.

In addition, when the chucked disk 12 is removed, operation opposite to the mounting operation described above is performed.

The chuck apparatus 10 of the embodiment provides the following effects and advantages.

(1) A scratch and a particle can be prevented from occurring.
(2) Both surfaces of a disk can be simultaneously inspected, and a short cycle time can be provided.
(3) A structure can be simple
(4) An area close to an inner circumference edge can be inspected.
(5) Because a disk 12 is held in a vertical attitude, an air flow from above by a clean air flow can be easily maintained in a laminar flow, and because turbulence does not occur behind the disk, the attachment of particles can be substantially reduced.
(6) Because a disk 12 is held in a vertical attitude, the disk 12 can avoid the attachment of particles falling due to the gravity from various mechanical structures disposed at the top (mechanical structures).
(7) Selection of the arrangement of the claws 16, 17, 18 and the claw material allows for improvement in stability in receiving a disk from the handling robot, and a scratch and a particle can be prevented from occurring due to friction at chucking.

### [Description of Disk Inspection Apparatus]

Then, an embodiment of a disk inspection apparatus (inspection apparatus for detecting dust attached to a disk) using the chuck apparatus 10 described above will be described.

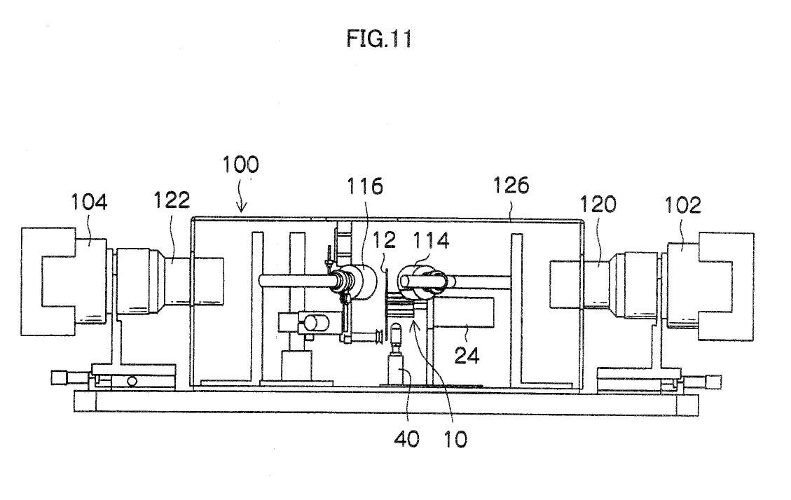

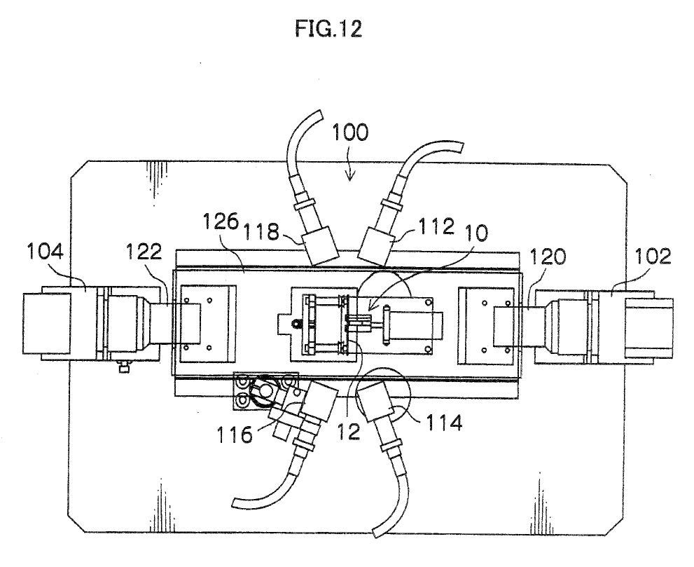

FIG. 10 is a perspective view showing a configuration of a disk inspection apparatus according to an embodiment of the present invention. FIG. 11 is a side view, and FIG. 12 is a plan view. As shown in these drawings, a disk inspection apparatus 100 includes: a camera 102 (corresponding to a “first imaging apparatus”) and a camera 104 (corresponding to a “second imaging apparatus”) disposed facing each other on both sides across a disk 12 held by the chuck apparatus 10; and illumination apparatuses 112, 114, 116, 118 disposed at positions in the lateral and slightly oblique directions of the disk 12. Lens portions for the cameras 102, 104 are designated by the reference numerals 120, 122, respectively.

A pair of the illumination apparatuses 112, 114 is corresponding to the “first illumination device”, and a pair of the illumination apparatuses 116, 118 is corresponding to the “second illumination device”.

In addition, a space around a disk 12 to be inspected is covered with a cover 126 during inspection to block disturbance light coming from the outside.

The cameras 102, 104 are electronic imaging apparatuses including image sensor elements having a high resolution and a long charge storage time (such as CCD and CMOS), and the embodiment has used CCD cameras having electronic cooling function. The CCD is preferable compared to the CMOS in view of a small dark current noise. Also, cooling the CCD allows a noise component of dark current to be reduced A cooling temperature is preferably not higher than 10° C. The lower the temperature is, the lower the dark current noise becomes, but at a long time operation, a problem may occur due to freeze if the cooling temperature is set not higher than 0° C., and in the embodiment, the cooling temperature has been controlled at 1° C. The charge storage time is preferably not shorter than 0.1 sec.

### <Configuration of Illumination Apparatus>

The illumination apparatuses 112 to 118, as shown in FIG. 13A, illuminate in a pattern coincident with a sector shape of an inspection range 130 of a disk 12 (an upper area of the disk 12 surrounded by its arc and lines that start at the center and form an angle of 45° between them), and the radiation pattern (sector-shaped pattern) is shaped using optical fibers 132, 134 (corresponding to the “light guide”), and projection lenses disposed on their ends (not shown), and the disk surface is illuminated in the pattern from end surfaces of the optical fibers 132, 134 of optical projection portions, in the oblique direction by a shallow angle relative to the disk surface (see FIG. 13B). An angle of attack of illumination light relative to the disk surface is preferably not greater than 30° (the incident angle is not smaller than 60°), and this apparatus has had the angle of attack of 20°.

Because a disk 12 used for a hard disk drive has a mirror finished surface, without suitable illumination applied, there may be reflection from an edge of the disk 12, blooming, an undesired image showing up on the disk surface (a phenomenon in that a lens of the camera or an illumination light source shows up on the surface of the disk 12) and the like, so that it becomes difficult to perform a high-accuracy inspection.

Then, in this embodiment, as shown in FIG. 13, only the inspection range 130 is radiated with white-light illumination light of an ultrahigh luminance (for example, not smaller than one million lx, preferably not smaller than two million lx) so that dust on the disk surface is emphasized in luminance, on the one hand an unnecessary area except the inspection range 130 is controlled not to be radiated, thereby preventing optical reflection from the claws 16, 17, 18 of the chuck, reflection from an edge of the disk 12, blooming, and an undesired image showing up on the disk surface.

Generally, a disk 12 has many concentric, circular and fine striae called “texture” (grooves having a concave or convex structure) formed on its surface. In the embodiment, the disk 12 is configured to be radiated in the line direction of the texture (in the tangential direction of the circumference) with illumination light. That is, as shown in the plan view of FIG. 13A, a pair of the illumination apparatuses 112, 114 (or 116, 118) is disposed to radiate in a manner that illumination light is parallel to the tangential direction of the texture.

Further, symmetric illumination from both sides to the disk 12 is also intended to uniform luminance in the radiation area (in the radiation pattern). In addition, as a high-luminance, white-light light source, a metal halide lamp can be used that has a high resolution and a large amount of light of 400 to 550 nm.

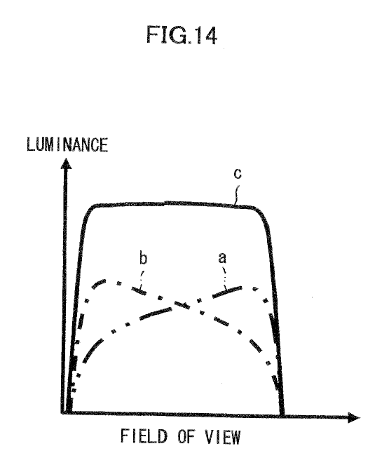

FIG. 14 shows a luminance distribution in the approximately sector-shaped radiation area radiated with illumination light by the illumination apparatuses 112 to 118. A luminance distribution provided by the illumination apparatus 112 (or 116) is shown by a graph (the alternate long and two short dashes line) designated by the reference character “a” in the figure, and a luminance distribution provided by the illumination apparatus 114 (or 118) is shown by a graph (the dashed line) designated by the reference character “b”. A luminance distribution in the radiation area (in the sector-shaped pattern) illuminated by the pair of the right and left illumination apparatuses 112, 114 (or the pair of 116 and 118) is a superposition of the graphs designated by the reference characters “a” and “b” as shown by a graph designated by the reference character “c”, resulting in an approximately constant luminance distribution in the entire field of view.

In addition, for inspection of an edge portion, illumination in, the texture aside, a plurality of circumferential directions is effective. An outer circumference edge includes a chamfered portion, and it is important to inspect the chamfered portion for the existence of attachment of dust.

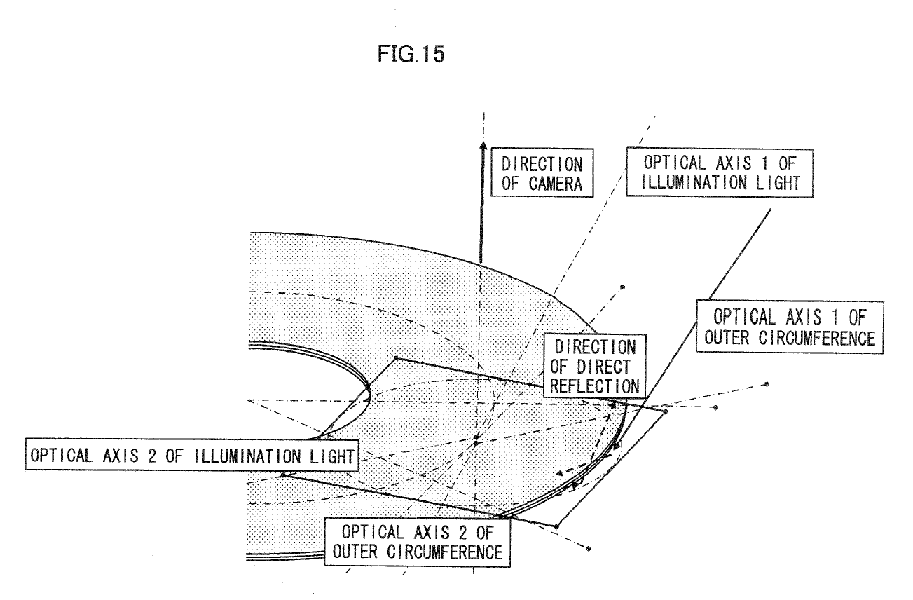

An illumination direction in which a disk end surface and a chamfered portion can be illuminated, and the chamfered portion does not directly reflect illumination light to the direction of the camera, as shown in FIG. 15, is the direction along the circumferential direction of the disk 12 (“outer circumference optical axis 1”, “outer circumference optical axis 2”). Further, when illuminated in the circumferential direction, a faraway edge is shaded, so that a plurality of illumination (in the “outer circumference optical axis 1” and the “outer circumference optical axis 2”) is required.

An area of which the camera 102, 104 takes an image one time is a sector-shaped portion in a range of 45° as shown in FIG. 13. After taking an image of the area, the disk 12 is rotated by 45°, and an image of a next inspection area is taken. Subsequently, similarly, rotating the disk by 45° changes the inspection area in turn to take an image, and images of the entire area of the disk 12 are taken.

### <Description of Inspection Facility (System)>

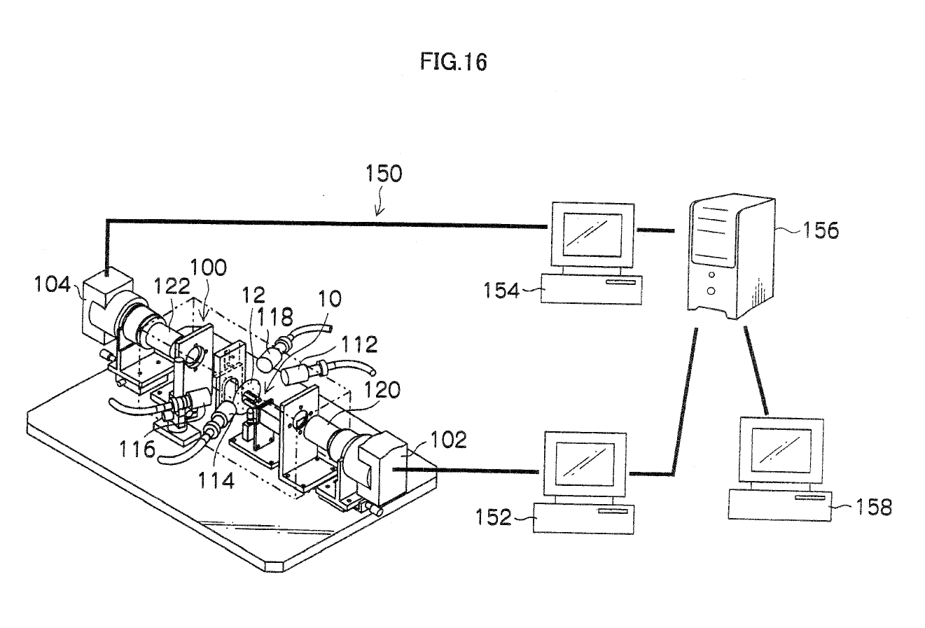

FIG. 16 shows an exemplary configuration of an inspection system including the disk inspection apparatus. This system 150 includes: a computer 152 for processing image data obtained from the camera 102 and controlling the entire system (image processing and system control computer); a computer 154 for processing image data obtained from the camera 104 (image processing computer); a data server 156; and a computer 158 for analyzing inspection image (analyzing computer). In addition, for a connecting device which connects the cameras (102, 104) to the corresponding computers (152, 154), respectively, and a connecting device which connects the data server 156 to each computer (152, 154, 158), a known communication interface can be used, without regard to wired or wireless.

The image processing and system control computer 152 controls the illumination apparatuses 112 to 118 (controls lighting/extinction, illumination intensity at lighting and the like), controls the cameras 102, 104 (controls timing for taking an image, an exposure time and the like), and controls the motor 24 of the chuck apparatus 10 (controls rotation of a disk 12 to change an inspection area and so on). Furthers the image processing and system control computer 152 primarily (preliminarily) processes image data obtained from the camera 102. The primary process includes a differential process for obtaining information of a difference between an inspection image and a dark image, and a nonlinear gradation conversion process for emphasizing dust.

Information of an inspection image obtained from the camera 102 is primarily processed by the image processing and system control computer 152, sent to the data server 156 by the image processing and system control computer 152, and stored in the data server 156. Similarly, information of an inspection image obtained from the camera 104 is primarily processed by the image processing computer 154 and stored in the data server 156.

The analyzing computer 158 analyzes and processes data stored in the data server 156. An example of analysis processing includes: image extraction of an area on the recording surface; image extraction of the outer circumference edge; image extraction of the inner circumference edge; respective detection of a position, the number, and a size of dust attached to each area of the area on the recording surface, and the edge areas on the outer and inner circumferences; the inspection result of the attachment of dust on the entire disk (judgment of acceptance or rejection, and the like); and further, as a measurement and analysis function, a mapping function for visually presenting the position and the size of dust on the disk for easy understanding.

The inspection data in the field of view (the inspection range of 45°) described above (eight pieces of the data) is joined together to obtain inspection data in an inspection range of 360°, and thereby where and how large dust attaches to the disk can be grasped. The analyzing computer 158 organizes information of a position, a size, the total number of dust and the like, compares with a predetermined criterion for pass/fail judgment, and judges good or not, so on. Information of the measurement results is stored in the data server 156.

In addition, the function of the analyzing computer 158 may be installed on the other computer (152 or 154).

### <Configuration of Software>

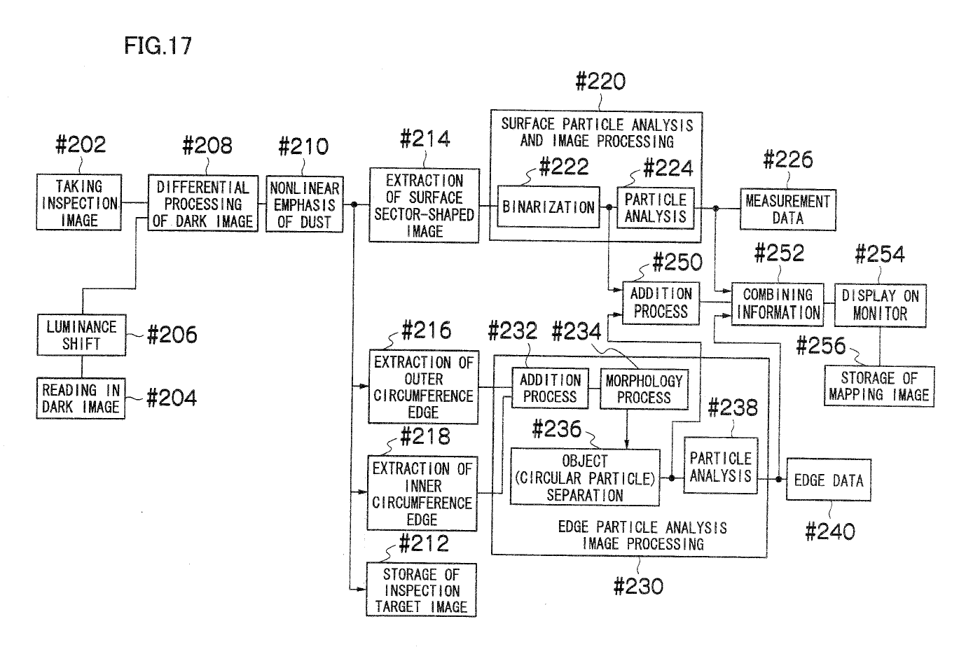

FIG. 17 is a processing block diagram showing a process flow performed by the inspection system of the embodiment. In addition, a processing function in each block is implemented by software (program).

First, the camera 102 (or 104) takes an image of a disk to be inspected (one shot; one area in the field of view), and obtains digital image data of an inspection image including a sector-shaped radiation range of illumination light (one-eighth of the disk area) on the disk to be inspected (#202).

While data of a dark image is read in that is beforehand obtained by taking an image with a lens of the camera 102 (or 104) being covered (#204), and for the dark image, computation of luminance shift (subtraction) is carried out using a predetermined constant (#206).

Then, in a dark image differential processing portion (#208), using the original inspection image of #202 and the dark image data of #204 as inputs, a process (differential process) is performed in which the dark image (a component of a dark noise) is subtracted from the original inspection image. Further, in a nonlinear dust emphasis processing portion (#210), the image data after the differential process is converted (for example, logarithmically converted) using nonlinear input/output characteristics to emphasize a location of dust. Data processed by the nonlinear dust emphasis processing portion (#210) is stored as an inspection target image (original image) (#212).

Also, based on the original image, each process of extraction of a sector-shaped image on the surface (#214), extraction of the outer circumference edge (#216), and extraction of the inner circumference edge (#218) is performed.

These extraction processes of the areas (#214 to #216) are conducted as described below.

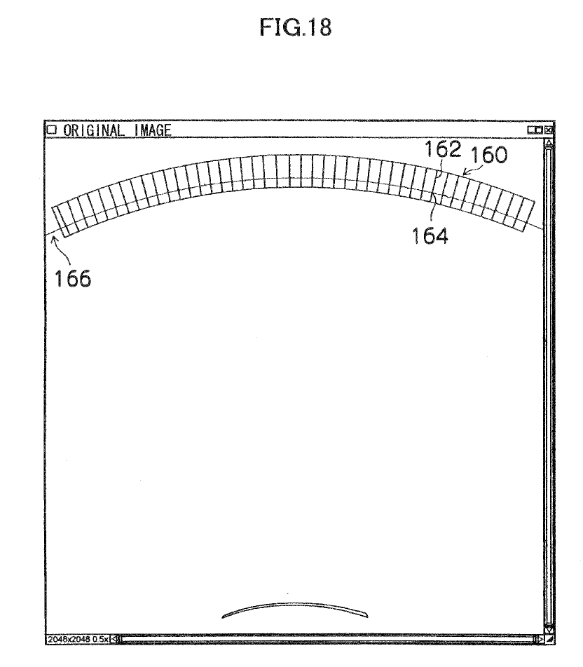

First, as shown in FIG. 18, concerning an area near the outer circumference edge of the disk in the original image, a processing window 160 is set, and in the processing window 160, a plurality of scanning positions is disposed to be equally spaced along the circumferential direction, and an edge point 164 of an object is detected by scanning on a straight line 162 along the radial direction at each scanning position.

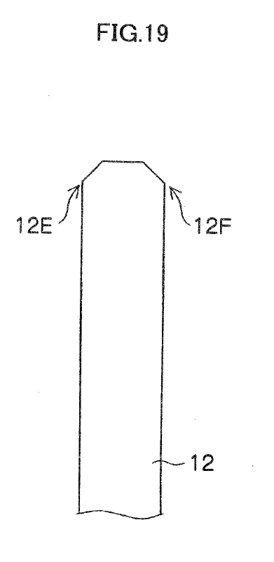

After the edge point 164 is detected at all the scanning positions, an outer circumference, circular line 166 is computed from the detected edge point 164. In addition, the computed outer circumference, circular line 166 at this time, as shown in FIG. 19, is a position of the inner or outer edge (the reference character 12E or 12F) of the chamfered, outer circumference end surface of the disk 12 obtained by the computation.

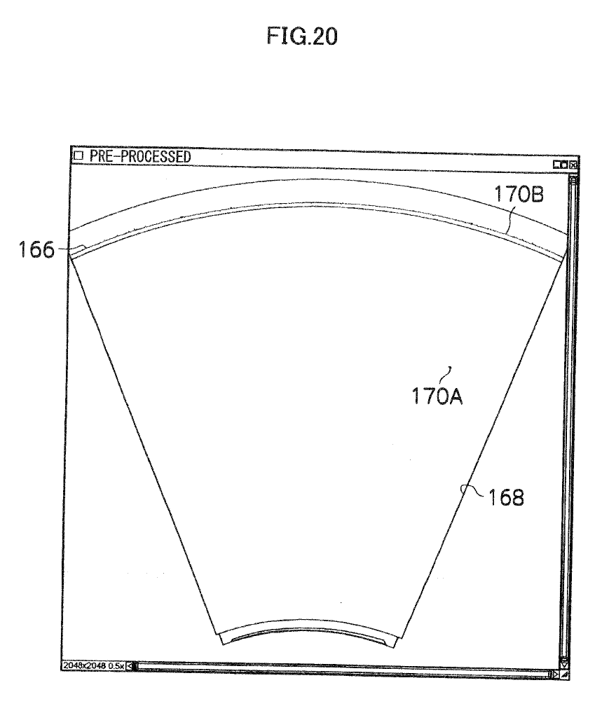

Further, a position of the center (coordinates) and a radius are computed from the obtained outer circumference, circular line 166, and a window 168 of the inspection area corresponding to the disk shape (sector-shaped inspection window having the range of 45° relative to the center) is depicted (see FIG. 20).

FIG. 20 shows an exemplary image in which a line of the inspection window 168 is added to the inspection image preliminarily processed, described above. An emphasis process, a differential process or the like is applied to an image pixel in the inspection window 168, which allows reflection from dust on the disk surface (objects in the image designated by the reference characters 170A, 170B) to be easily grasped.

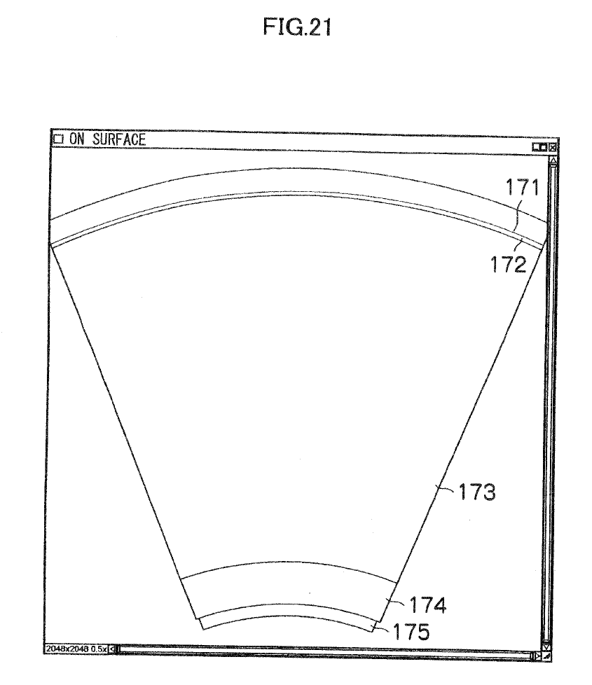

Also, based on a design value of the disk 12 to be inspected, the sector-shaped window image, as shown in FIG. 21, can be divided into five areas (processing windows): an outer circumference edge area 171, an outer surface area not for recording 172, an recording surface area 173, an inner surface area not for recording 174, and an inner circumference edge area 175. The number of dust and the like can be measured for each of the areas.

The “outer surface area not for recording 172”, the “recording surface area 173”, and the “inner surface area not for recording 174” correspond to the sector-shaped image on the surface, and a surface particle analysis image process (#220 in FIG. 17) is applied to the sector-shaped image on the surface. The surface particle analysis image process (#220) is configured to include a binarization process (#222) and a particle analysis process (#224).

The binarization process (#222) is a process in which a digital value (gradation value) of an image signal is compared with a predetermined threshold to extract a portion having a higher luminance than the threshold. If there is dust on the disk surface, the dust scatters illumination light, and the dust shows up in an image as a bright point depending on a size of the dust. Dust can be detected by comparison with a preset threshold according to a level of the dust to be detected. The binarization process separates a pixel corresponding to dust (target to be processed). An object of an area or a group in which pixels having the same luminance level obtained by the binarization process (#222) join together is defined as a “particle”.

The particle analysis process #224) includes an analytic function for creating information of a particle in an image, and acquires information of a position, a shape, a size, the number and the like of a particle. Data of measurements of each item obtained by the particle analysis process (#224) is stored in a file as measurement data (#226).

On the one hand, an edge particle analysis image process (#230) corresponding to an issue unique to an edge area is applied to the “outer circumference edge area” and the “inner circumference edge area”. That is, the edge portion of a disk includes factors such as reflection from the chambered portion, a deposition defect, and a scratch, except dust, so that to the edge area, a process is applied in which factors except dust and dust (particle) are separated, and only the dust is detected. In the inner edge processing, only the portion without the claws 16, 17, 18 is inspected by switching depending on the existence of the claws 16, 17, 18.

The edge particle analysis image process (#230) is configured to include an addition process (#232), a morphology process (#234), a circular particle separation process (#236), and a particle analysis process (#238).

The addition process (#232) is a process in which information of the outer circumference edge area and information of the inner circumference edge area are superposed.

The morphology process (#234) is a process for deforming a figure by computation between images, and here, first, reduction is carried out, and enlargement then is done. An image portion showing up due to reflection from the chambered portion and a scratch such as a deposition defect is an elongated, band-shaped line along the edge line, but an image portion showing up due to dust (particle) has generally a circular shape individually reflecting dust, or a continuous shape (daisy-chained shape) in which a circular shape individually corresponding to dust is partially overlapped with each other when a plurality of dust is adjacent to each other and attached. Then, the morphology process (reduction, and subsequently enlargement) removes the image portion showing up due to reflection from the chamfered portion and a scratch such as a deposition defect, as a noise component, and the image portion showing up due to dust (particle) is left behind in an emphasized condition. In addition, instead of the morphology process, or combined with this, a process may be used that judges an “aspect ratio”.

The circular particle separation process (#236) is a filter for separating a circular particle from the data after the morphology process (#234), and includes: a process for separating an object based on a neck portion of the image portion having the daisy-chained shape and a varying width; and a circle detection process for detecting a circular particle based on circularity and the like of an individual object to be separated.

The particle analysis process (#238) includes an analytic function for creating information of the circular particle whose object is separated, and acquires information of a position, a shape, a size and the number of the particle. Data of measurements of each item obtained by the particle analysis process (#238) is stored in a file as edge data (#240).

The image of a particle obtained by the binarization process (#222) in the surface particle analysis image process (#220) and the image of a particle obtained by the object separation process (#236) in the edge particle analysis image process (#230) are superposed on each other in the addition process (#250), and character information (numerical label) of the measurement result obtained by the particle analysis processes (#224, #238) is assigned to each particle on the image to be combined (#252), and is displayed on a monitor as the inspection result (#254). An image to which this measurement result is mapped is stored in a file as a mapping image (#256).

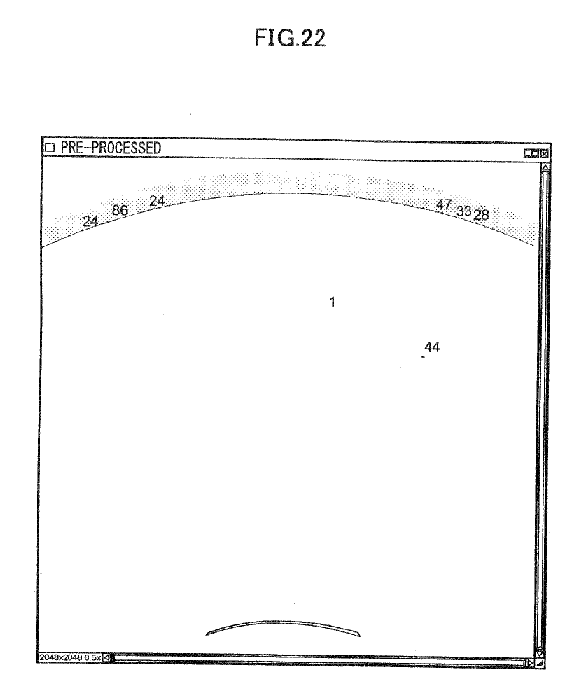

FIG. 22 shows an exemplary image of the inspection result. A numerical label given to a particle (dust) shows a size of the particle. A display color may be preferably set differently depending on whether a particle size is in an acceptable range or not, or where dust attaches. An acceptable particle size may be differently set depending on whether a position at which dust attaches is in the edge area or in the surface area.

For example, a blue numerical label may show the measurement result in the edge area. A green numerical label may show the acceptable measurement result (the result: OK) in the surface area. A red numerical label may show the measurement result when judged to be beyond the acceptable range and bad (NG).

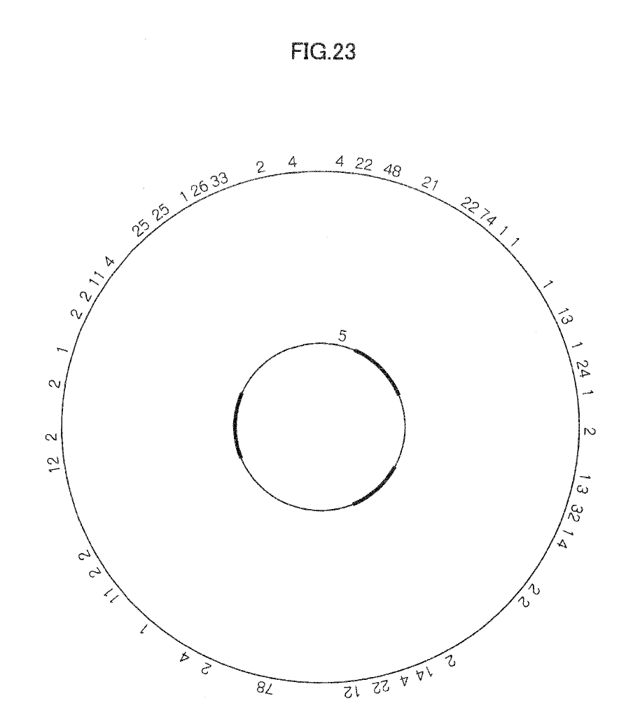

Joining together eight measurement results (corresponding to the inspection range of 360°) of the sector-shaped inspection area having the range of 45°, as shown in FIG. 23, allows the measurement results of the entire surface of the disk to be displayed.

### <Exemplary System Control>

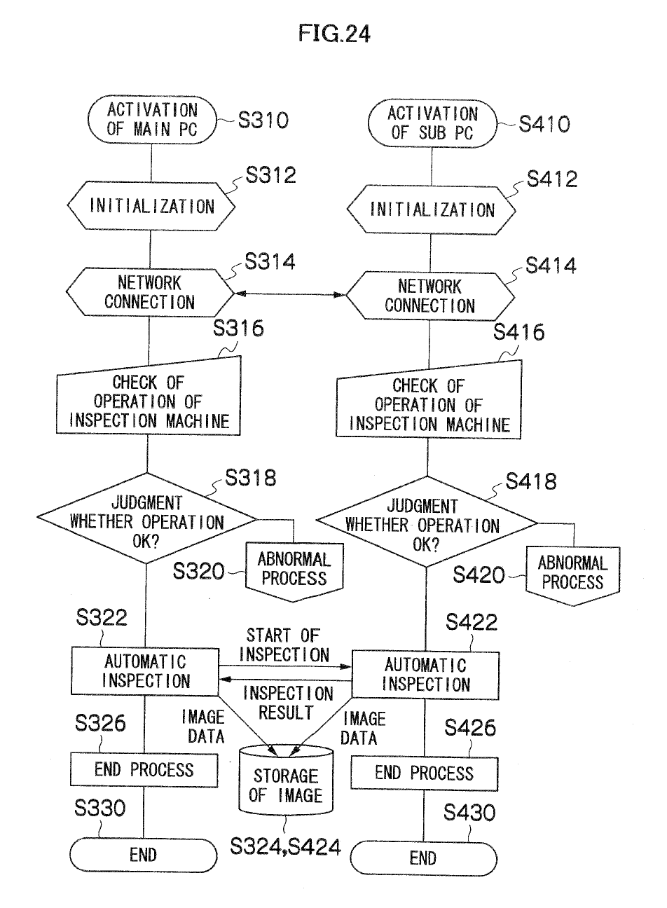

FIG. 24 is a flow chart showing an example that the system is controlled using two computers. Processing of a main PC shown on the left side in FIG. 24 corresponds to that of the computer designated by the reference numeral 152 in FIG. 16, which is responsible for inspection of a first surface of a disk 12 (for example, front face). Also, processing of a sub PC shown on the right side in FIG. 24 corresponds to that of the computer designated by the reference numeral 154 in FIG. 16, which is responsible for inspection of a second surface of the disk 12 (for example, back face).

Here, an example will be described that two computers for front face inspection and back face inspection are used to carry out alternately processes in consideration of load of image transfer and image processing, but a computer having a high processing speed and processing power can execute the processes processed by the two computers.

As shown in FIG. 24, the main PC and the sub PC are started, respectively (step S1310, S410), and initialized (step S312, S412), and subsequently network connection is established (step S314, S414).

Then, operational check is performed on an inspection machine according to cooperation between the chuck apparatus 10 and each of the cameras 102, 104 (step S316, S416). The operational check may be automatically conducted on a predetermined check item according to a predetermined program, or an operator may perform operation such as numerical value entry, as needed.

Whether the inspection machine operates normally or does not is judged based on processing of the operational check (step S318, S418), and if confirmed abnormal, a predetermined process for handling (abnormal process) is performed (step S320, S420). While, if confirmed normal, processes for automatic inspection are started (step S322, S422).

The details will be described below, and in the embodiment, taking an image of the front face of the disk and taking an image of the back face of the disk are alternately performed. First, the main PC takes a first image, and after taking it, the main PC sends a command for inspection start to the sub PC, and the sub PC that received the command takes an image of the back face. After the sub PC takes the image and inspection (image analysis processing) thereof is completed, the inspection result is sent to the main PC. Also, image data processed by the main PC (inspection target image data and mapping image data) is sent to a server computer, and stored in a storage area of the server computer (step S324, S424).

After the image data of each of the front face and the back face is acquired, the chuck apparatus is driven to rotate the disk 12 by 45° and stop, similarly to the described above, images of the front and back faces are taken, and each of the inspection images is analyzed. In such a manner, images of the front and back faces are taken at each stop position of the position of 0°, the position of 45° the position of 90°, the position of 135°, the position of 180°, the position of 225°, the position of 270°, and the position of 315° while rotating the disk by 45°, and for one disk, 8 pieces of image data (sector-shaped image) per surface, so 16 pieces of the image data per both surfaces are acquired.

After all inspection is completed, an end process is performed (step S326, S426), and processing ends (step S330, S430).

Next, processing of automatic inspection will be described.

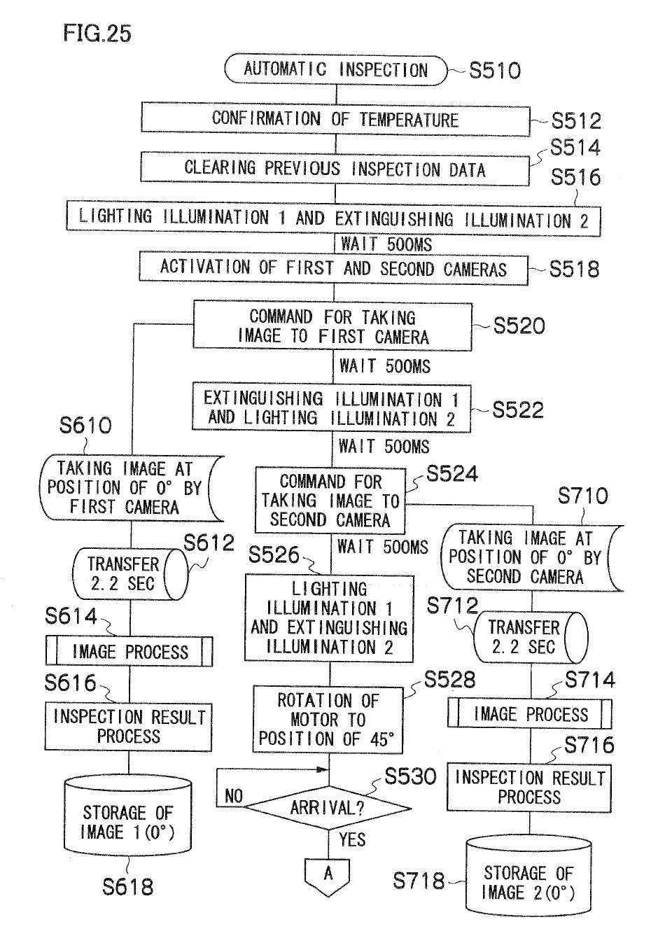

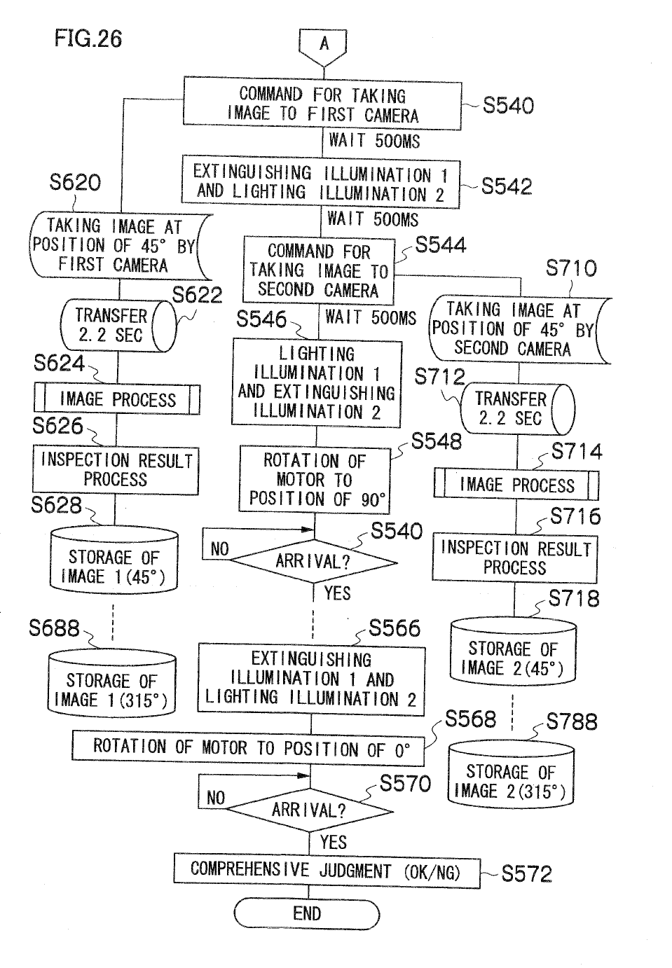

FIGS. 25 and 26 are a flow chart showing processing procedures for automatic inspection. The central flow in each figure is a system control flow executed by the main PC, and the left flow is a flow of taking an image by a first camera (corresponding to the reference numeral 102 in FIG. 10, abbreviated as a “first camera”) and image processing, and the right flow is a flow of taking an image by a second camera (corresponding to the reference numeral 104 in FIG. 10, abbreviated as a “second camera”) and image processing. In addition, in this system, the main PC is responsible for system control and processing of the first camera. Also, the sub PC is responsible for processing of the second camera.

When the automatic inspection processing starts (step S510), first, a temperature is checked (step S512), and the previous inspection data is cleared (step S514). Then, a pair of illumination apparatuses on the side of the first camera (abbreviated as an “illumination 1”) is lit (ON), and a pair of illumination apparatuses on the side of the second camera (abbreviated as an “illumination 2”) is extinguished (OFF) (step S516). After waiting for a predetermined time (for example, 500 ms), the first and second cameras are started (step S518), and a command for taking an image is given to the first camera (step S520). At this time, the server creates a holder dedicated to the first and second cameras, respectively, and prepares for storage of an inspection image. The names of the holders, for example, are automatically created as “sample name+serial number+first camera”, and “sample name+serial number+second camera”.

Based on the command for taking an image at step S520, the first camera takes an image at the position of 0° (the initial position when the chuck apparatus controls to rotate the disk) (step S610). Data of the image taken by the first camera is transferred to a computer (here, the main computer) (step S612). In the embodiment, for the transfer time, 2.2 sec is secured.

The computer executes image processing of the image acquired according to the software described with respect to FIG. 17 (step S614 in FIG. 25), and combination processing of the inspection result into the image surface (step S616). A mapping image of the inspection result obtained in such a manner and an inspection target image (the original image) are stored in a dedicated holder of the server (step S618).

A file name is automatically created as “sample name+serial number+(X, Θ). Here, “X” of (X, Θ) is a variable for showing distinction between the first camera and the second camera, and for an image taken by the first camera, X=1, and for an image taken by the second camera, X=2. “θ” is a variable for identifying a position at which an image of a disk is taken, and there are eight types: Θ=0 deg, 45 deg, 90 deg, . . . 315 deg. In the figure, an image taken by the first camera is shown as “image 1”, and an image taken by the second camera is shown as “image 2”.

At step S520, a command that the first camera take an image is output, and after the first camera takes an image, and waiting for a predetermined time (for example, 500 ms), the illumination 1 is extinguished and the illumination 2 is lit (step S522). Then, after waiting for a predetermined time (for example, 500 ms), a command for taking an image is given to the second camera (step S524).

Based on the command for taking an image, the second camera takes an image at the position of 0° (step S710). Data of the image taken by the second camera is transferred to a computer (here, the sub PC) (step S712). For a transfer time, in the embodiment, 2.2 sec is secured.

The computer executes image processing of the image acquired, according to the software described with respect to FIG. 17 (step S714 in FIG. 25), and combination processing of the inspection result into the image surface (step S716). A mapping image of the inspection result obtained in such a manner and an inspection target image (the original image) are stored in a dedicated holder of the server (step S718).

At step S524, a command that the second camera take an image is output, and after the second camera takes an image, and waiting for a predetermined time (for example, 500 ms), the illumination 1 is lit and the illumination 2 is extinguished (step S526), and the motor of the chuck apparatus is driven to rotate the disk to the position of 45° (step S528). The rotation of the motor is monitored to arrive at the position of 45′ (step S530), and when the arrival at the predetermined position is confirmed, the motor is stopped.

Subsequently, proceed to step S540 in FIG. 26, a command for taking an image is given to the first camera (step S540).

Based on the command for taking an image at step S540, the first camera takes an image at the position of 45° (step S620). Through subsequent, predetermined processes (steps S622 to S628), a mapping image of the inspection result and an inspection target image (the original image) at the position of 45° are stored in a dedicated holder of the server (step S628). In addition, the processes of steps S622 to S628 are similar to those of steps S612 to S618 described with respect to FIG. 25, and description thereof will be omitted.

At step S540 in FIG. 26, a command that the first camera take an image is output, and after the first camera takes an image, and waiting for a predetermined time (for example, 500 ms), the illumination 1 is extinguished and the illumination 2 is lit (step S542). Then, after waiting for a predetermined time (for example, 500 ms), a command for taking an image is given to the second camera (step S544).

Based on the command for taking an image, the second camera takes an image at the position of 45° (step S720). Through subsequent, predetermined processes (steps S722 to S728), a mapping image of the inspection result and an inspection target image (the original image) at the position of 45° are stored in a dedicated holder of the server (step S728). In addition, the processes of steps S722 to S728 are similar to those of steps S712 to S718 described with respect to FIG. 25, and description thereof will be omitted.

At step S544 in FIG. 26, a command that the second camera take an image is output, and after the second camera takes an image, and waiting for a predetermined time (for example, 500 ms), the illumination 1 is lit and the illumination 2 is extinguished (step S546), and the motor of the chuck apparatus is driven to rotate the disk to the position of 90° (step S548). The rotation of the motor is monitored to arrive at the position of 90° (step S550), and when the arrival at the predetermined position is confirmed, the motor is stopped.

Description of subsequent operation will be omitted, and similarly to the described above, taking an image by the first camera and taking an image by the second camera are alternately performed to acquire an image at each position of the position of 135°, the position of 180°, the position of 225°, the position of 270°, and the position of 315°, and each image is analyzed to inspect. In such a manner, similar processes are repeated, and after taking an image and storing an image at the position of 315° (steps S688, S788) are completed, both of the illuminations 1 and 2 are extinguished (step S566).

Then, the motor of the chuck apparatus is driven to rotate to the position of 0° (step S568). The rotation of the motor is monitored to arrive at the position of 0° (step S570), and when the arrival at the predetermined position is confirmed, the motor is stopped

As described above, 8 inspection images per each of the front and back faces, namely 16 inspection images in total are comprehensively evaluated to judge pass/fail on the inspection (OK/NG) (step S572). A criterion for pass/fail judgment can be appropriately set and changed by an operator through an input device such as a key board, and based on the criterion set for pass/fail judgment, the inspection result is automatically judged according to the program, and the judgment result is reported (displayed on a display). Further, use of the judgment result can control a separation apparatus to automatically separate between a disk judged pass and a disk judged fail on the inspection.

### <Flow of Disk Inspection>

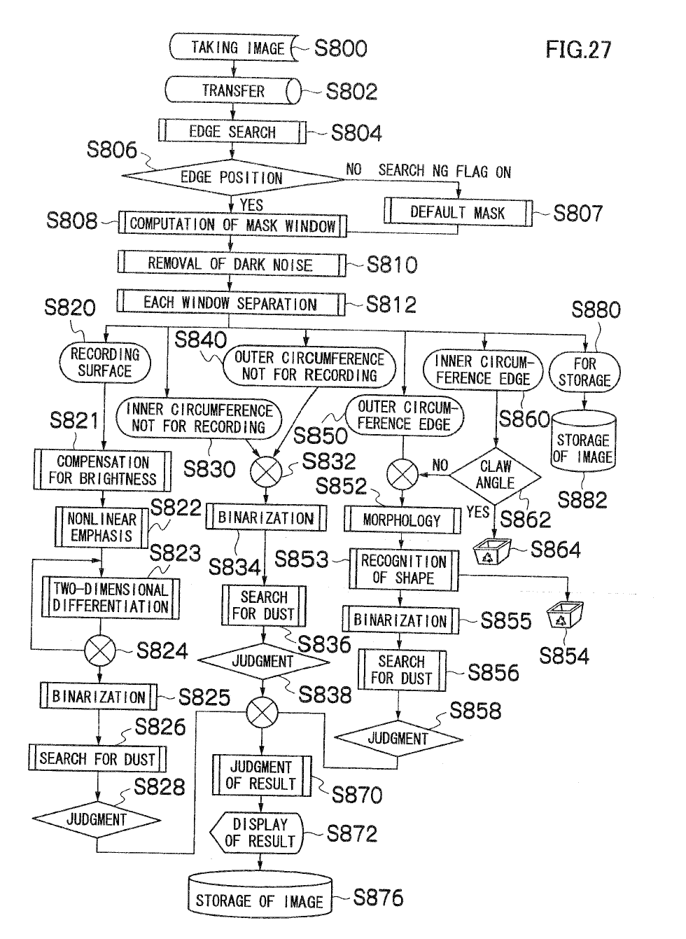

FIG. 27 is a flow chart showing processing procedures of disk inspection according to an embodiment.

An image of a disk to be inspected is taken by a CCD camera (step S800), and data of the taken image is transferred from the CCD camera to a computer (PC) (step S802).

The computer, first, applies an edge search process to the taken image (step S804). The edge search process is a computational process for detecting an edge position of the disk (outer circumference edge position), and when the edge search process finds the edge position (“YES” at step 8806), based on this, a mask window is computed to set a window (inspection window) (step S808).

On the one hand, when the edge search process does not find the edge position, and a “NO” is provided in Judgment of the edge position at step S806, then a search NG flag is set ON, and a default mask is applied (step S807).

Next, a process is executed that removes, from the taken, raw image, a dark noise which each pixel (light receiving cell) of a CCD has (step S810). A dense black image is taken in advance to acquire data of the dark noise, and the data of the dark noise is subtracted from the inspection image (raw image) to remove a dark noise component.

The image obtained in such a manner is processed to be divided into five windows corresponding to each of: a “recording surface (recording area where a servo signal and the like are to be written)”, an “inner circumference area not for recording”, an “outer circumference area not for recording” an “outer circumference edge area”, and an “inner circumference edge area” (step S812). Each of the areas corresponds to the “recording surface area 173”, the “inner surface area not for recording 174”, the “outer surface area not for recording 172”, the “outer circumference edge area 171”, and the “inner circumference edge area 175”, respectively.

The window separation process uses information of the specifications of a hard disk to be inspected. Assuming that in the specifications, an inner diameter of the hard disk be R1, an outer diameter be R2, and a recording area be a range from the center of the disk, from a radius Ra to a radius Rb (R1<Ra<Rb<R2). Also, the inner circumference area not for recording be a range from the center of the disk, from a radius Rc to the radius Ra, and the outer circumference area not for recording be a range from the center of the disk, from the radius Rb to a radius Rd (R1<Rc<Ra<Rb<Rd<R2).

As a way for entering the information of the specifications, an operator may manually input through an input apparatus such as a keyboard or a mouse of the computer, or there may be an aspect in which a plurality of pieces of information of the specifications corresponding to disks of a plurality of types is beforehand stored in a memory storage of the computer, and the specifications to be applied (type of disk) are selected at inspection, alternatively, there may be an aspect in which the specifications are read into from a storage medium such as a memory card.

With reference to such information of the specifications, the taken image is processed so that the range from the radius Ra to the radius Rb from the center of the disk is set to a “window for the recording surface”, the range from the radius RC to the radius Ra is set to a “window for the inner circumference not for recording”, the range from the radius Rb to the radius Rd is set to a “window for the outer circumference not for recording”, the range from the radius Rd to a radius Re is set to a “window for the outer circumference edge”, and the range from a radius Rf to the radius Re is set to a “window for the inner circumference edge”. Where, Re has a predetermined value satisfying R2<Re, and Rf has a predetermined value satisfying Rf<R1.

For example, in the case of the disk having an outer diameter of 2.5 inches (R1=10 mm, R2=32.5 mm), the dimensions are determined so that Ra=5 mm, Rb=30 mm, Re=33.0 mm, and Rf=9.5 mm.

The taken image is divided into the five windows in such a manner, and a flow of processing is branched correspondingly to each window. Then, a processing routine of the window for the recording surface (step S820), a processing routine of the window for the inner circumference not for recording (step S830), a processing routine of the window for the outer circumference not for recording (step S840), a processing routine of the window for the outer circumference edge (step S850), a processing routine of the window for the inner circumference edge (step S860) and a processing routine for storage (step S880) will be described below.

### <Window for Recording Surface>

The image of the recording surface portion, as needed, is compensated for brightness (step S821), and subsequently, a nonlinear emphasis process (step S822) is executed, and a two-dimensional differential process is executed (step S823). In addition, the compensation process for brightness (step S821) may be omitted. The two-dimensional differential process (step S823) can separate between texture and a component due to showing up undesirably by removing a moderate difference in luminance by setting a threshold.

Data obtained by the two-dimensional differential process (step S823) in such a manner is added to data obtained by the nonlinear emphasis process (step S822) before the differential process (step S824), and a binarization process (step S825) is executed.

Then, the binarized image is searched for dust (step S826). The dust search process (step S826), here, corresponds to the particle analysis process (#224) described with respect to FIG. 17.

As described above, information of a position, a shape, a size and the number of particles is acquired, and whether these are in the acceptable range (OK), or at the undesirable level beyond the acceptable range (NG) is judge (step S828 in FIG. 27).

### <Window for Inner Circumference not for Recording and Window for Outer Circumference not for Recording>

Images corresponding to the inner circumference area not for recording and the outer circumference area not for recording are binarized (step S834), respectively, and subsequently searched for dust (step S836), and based on the obtained information, whether in the acceptable range (OK), or at the undesirable level beyond the acceptable range (NG) is judged (step S838). The specific contents of processing are similar to those of steps S826 to S828. In addition, a process stage designated by the reference character S832 in the figure represents switching of an input signal.

### <Window for Outer Circumference Edge>

The outer circumference edge portion, as described with respect to #234 in FIG. 17, is processed in a morphology process (step S852 in FIG. 27) and subsequently in a shape recognition process (step S853). The shape recognition process (step S853) corresponds to the object separation (circular particle separation) process (#236) described with respect to FIG. 14, and for example, it computes ellipticity (aspect ratio) to judge what has an approximately circular form to be dust and what has an elongated form to be a scratch or a deposition defect.

After the shape (dust) from which a pixel can be separated by the morphology process, and the shape from which a pixel cannot be separated (shape where a plurality of pixels is linked to each other, that is, a scratch and a deposition defect) are separated, only the information of dust is left behind and the information of a scratch (defect) is removed (step S854).

In such a way, the image including the information of dust is binarized (step S855), and the binarized image is searched for dust (step S856) and judged (step S858). The dust search process (step S856) corresponds to the particle analysis process (#224) described with respect to FIG. 17, and the judgment step (step S858) is similar to steps S828 and S838.

### <Window for Inner Circumference Edge>

Whether the inner circumference edge portion corresponds to an image situated at the same angular positions as those of the claws 16, 17, 18 on the chuck apparatus 10 or not is judged (step S862), and only when not coincident with the claw angles (judgment of “NO” at step S862), processes similar to those in the case of the outer circumference edge portion (steps S852 to S858) are applied. When coincident with the claw angles judgment of “YES” at step S840), dust analysis processing of the inner circumference edge is skipped (step S864).

As described above, the dust search of each processing window and the judgment result thereof are aggregated (step S870), and the result can be displayed on a monitor as the inspection result (step S872).

Concerning displaying the result, the result is superposed on the inspection image by an image processing engine for overlay presentation. That is, the taken image is inverted from a negative to positive image, and a position of dust is plotted on it, and a label showing a size of the dust, then, is attached. Because a taken image from a CCD camera is an image having a whitely bright point of dust against a black background, for displaying the inspection result on a monitor, the taken image is inverted from a negative to positive image to create an image having a black point of dust against a white background. Then, on this inverted image, a position of dust detected in the dust search (steps S826, S836, S856) is plotted, and also a numeric value representing a size of each dust is attached. When dust has a dust size in a predetermined, acceptable range for each of the areas, a green or blue label is attached thereto, and to dust having a size beyond the acceptable range, a red label is attached (see FIG. 22).

As described above, a mapping image to which overlay representation of the information of dust is added is output to a display of the computer or other display device for monitoring, and stored as an image file (step S876), while a position and a size of dust is stored in another file as text data.

Further, at step S812, at executing the each window separation process, the original image is also stored in an image file for save (step S882).

The disk inspection apparatus 100 according to the embodiment has the following advantages.

(1) A minimum detection resolution of 0.1 μm can be achieved.
(2) Without a disk having to be handled (inverted), both surfaces can be simultaneously inspected.
(3) Not only a recording surface, but an outer circumference edge area and an inner circumference edge area can be inspected for the attachment of dust.
(4) An image showing up undesirably on a recording surface and abnormal reflection from an edge of a disk or a claw of the chuck apparatus 10 can be prevented.
(5) An effect by a sensitivity difference between on a flat portion and an edge portion of a hard disk can be avoided. A sensitivity at detecting dust attached to the hard disk from an taken image is about 100 times higher on the flat portion than on the edge portion, and only by setting a common threshold level, either the flat portion or the edge portion cannot be dealt with, but because, in the embodiment, the inspection image is divided into five areas, and each area is processed in an appropriate image process, the flat portion and the edge portion can be inspected simultaneously.
(6) A cheap CCD camera having about 4 million pixels can be used to take an image of one-eighth of an area of a disk (equivalent to about 30×30 mm of a 2.5-inch disk) at a time to inspect. Generally, when dust on a surface is to be detected, and a defect of a sub-μm size is assigned to one pixel, then only the area of 4×4 mm can be detected due to the resolution of the CCDs. On the other hand, according to the embodiment, dust finer than the resolution of the image sensor elements can be detected because the embodiment employs a configuration in that a taken image is emphasized by the nonlinear emphasis processing and the two-dimensional differential processing, and subsequently superposed on a high-luminance raw image to be binarized, showing up a defect.
(7) The two-dimensional differential process is applied to a recording surface, and an appropriate threshold is set, for example, to remove a value smaller than a specified threshold, thereby a moderate difference in luminance can be removed. Accordingly, a phenomenon can be avoided that undesired reflection from texture on a disk surface, and a background such as a lens showing up undesirably due to a mirror finished surface of the disk surface constitute a noise in detection of dust.
(8) The algorithm formed by combining the morphology process with the shape recognition process is applied to an edge portion, and thereby a defect such as a scratch and dislocation of deposition except dust on the edge can be separated from attached dust.
(9) The image data of 16 bits can be processed to extract information of fine dust generally having 8 bits.
(10) During inspection, a position and a size of dust can be visually judged on a monitor because the inspection image (raw image) is inverted, the position of dust is plotted thereon, and a label corresponding to the dust size is attached, and the inspection result, then, is displayed on a monitor.

### <Further Features of Illumination Optical System>

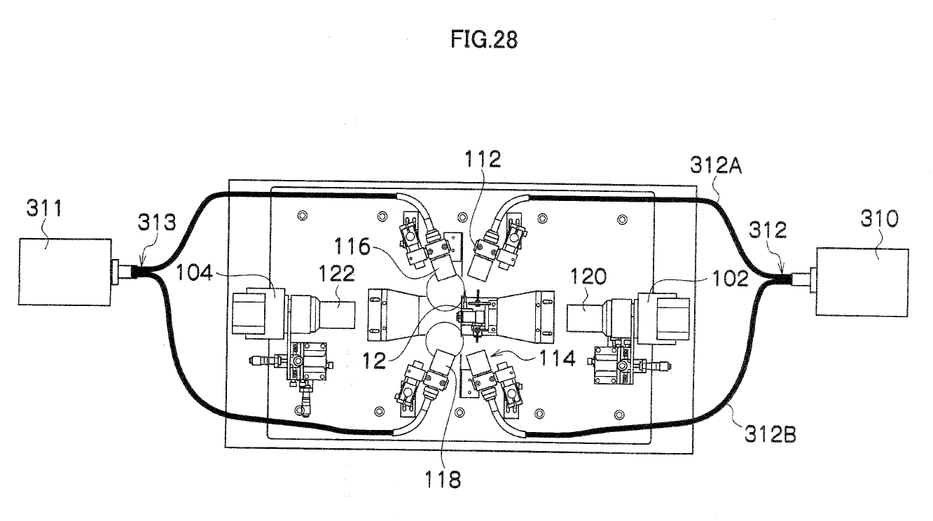

FIG. 28 is a plan view showing an exemplary configuration of an illumination optical system. As shown, in an embodiment, for each of inspection surfaces on the front face side and the back face side of a disk 12, one light source apparatus 310, 311 is provided, respectively, and for one surface of the disk 12, an optical fibers cable 312 (or 313) is configured to branch into two from the one light source apparatus 310 (or 311) and to illuminate an inspection area of the disk symmetrically from the two directions (the right and left directions). For both inspection areas on the front face side and the back face side of the disk 12, the system is similarly configured, so that only one of the illumination optical systems (on the right side in FIG. 28), here, will be described.

As described with respect to FIG. 13 the illumination apparatuses 112, 114 in the embodiment perform pattern illumination in which only the inspection area of the disk 12 (inspection range 130) and the periphery thereof are radiated with illumination light having approximately the same shape as the inspection area.

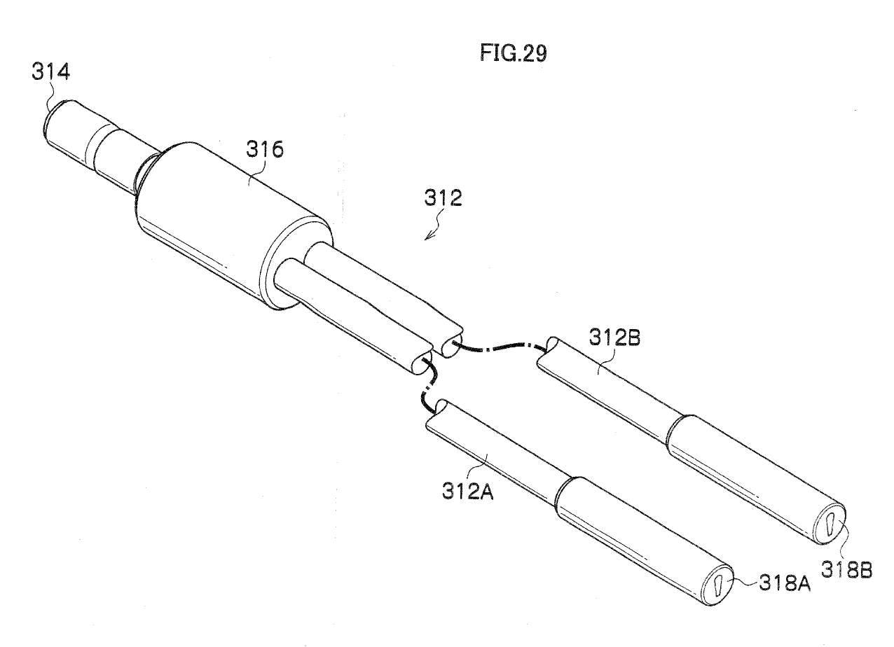

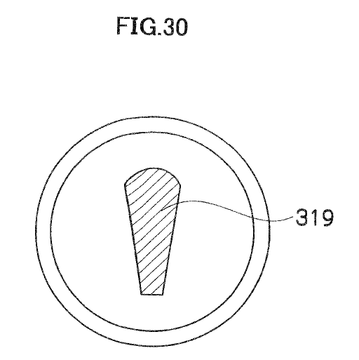

FIG. 29 is a perspective view showing the optical fibers cable used in this embodiment. The optical fibers cable 312 used as a light guide is configured by bundling many fiber wires of a small diameter and forming an exit end surface in a predetermined shape, and ends 314 on the incident side of the optical fibers cable 312 are bundled into one, and the fibers branch into two paths on the way. Each fibers bundle (the reference characters 312A, 312B) which branches from a branch portion 316 is a bundle having the same number of fibers (each having a halt) and a half of an amount of light. Also, a fibers bundle shape of an exit end surface 318A, 318B of each branched, optical fibers cable 312A, 312B has an end surface shape as designated by the reference numeral 319 (hatched portion) in FIG. 30 in order to form a sector-shaped range of delivery of illumination light on the disk surface.

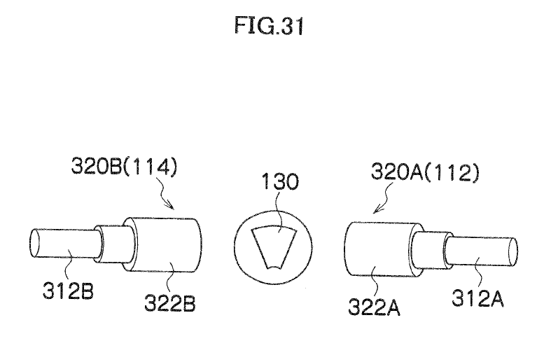

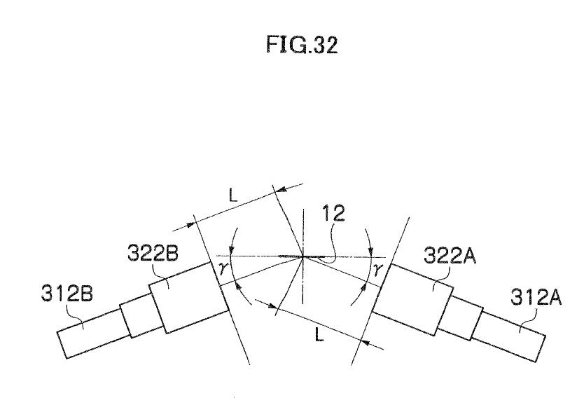

FIG. 31 shows a periphery of an optical projection portion of the illumination apparatus, seen from the front side directly facing the disk surface, and FIG. 32 is a plan view of FIG. 31. In these drawings, each optical projection portion designated by the reference characters 320A, 320B is an optical projection portion of the illumination apparatus 112, 114 shown in FIG. 28, respectively.

In FIG. 32, a lens is designated by the reference characters 322A, 322B, respectively, and each lens 322A, 322B is mounted on a distal end of the optical fibers cable 312A, 312B, respectively. In addition, the reference characters 312A, 312B in FIGS. 31, 32 correspond to the reference numerals 132, 134 described with respect to FIG. 13A, respectively.

As shown in FIGS. 31 and 32, in the optical fibers cable 312A, 312B having the lens 322A, 322B, a radiation distance and a radiation position are adjusted and aligned so that a shape of pattern illumination lies, approximately at a focus position, on a shape of the sector-shaped portion (the reference numeral 130) of the inspection area on the disk surface. At this time, a position of the lens 322A, 322B is adjusted relative to the sector-shaped inspection area, so slightly shifted toward a defocus position to radiate a range including the entire inspection area and further slightly wider than the inspection area. If the illumination light is focused on the disk surface, there is a problem that a non-uniform pattern of the fibers bundle shows up, and non-uniformity in luminance is preferably reduced by defocusing. In addition, a quantity of defocusing on the disk surface can be adjusted by adjusting a relative position between the lens 322A, 322B and the distal end of the fibers, and adjusting a distance between the lens 322A, 322B and the disk surface.

A specific radiation distance and the like are designed depending on conditions such as a focal distance of the lenses used, for example, a distance between the distal end of the lens and the disk 12 to be inspected (radiation distance L) is appropriately set in a range of 50 to 100 mm.

Further, an angle γ made between the disk surface and a radiation optical axis of illumination light is preferably in a range of 0° to 30°, and in this embodiment, γ has been set to 20° (incident angle=70°) (see FIG. 32). When the angle made between the disk surface and the radiation optical axis becomes larger than 30°, an image of the illumination apparatuses 112, 114 shows up, and reflected light is directly incident on the camera 102 (104). Accordingly, to accurately detect dust attached to the disk 12, illumination is preferably performed in a shallow angle. Further, when the angle made between the disk surface and the radiation optical axis is not larger than 0°, light is “kicked out” by the disk 12 to be inspected to form a shade, and dust cannot be brightened.

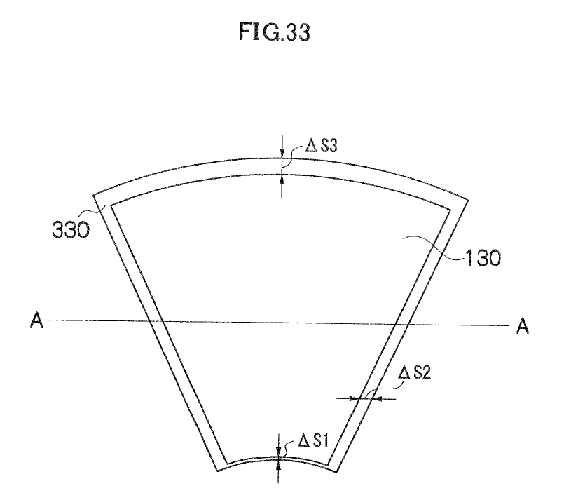

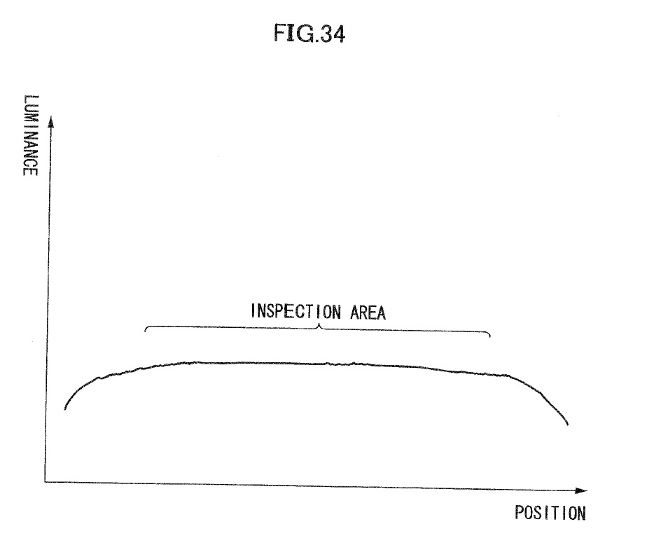

FIG. 33 shows the relation between the sector-shaped inspection area and the range of delivery of defocused illumination light in the pattern. As shown, the range of delivery of pattern illumination 330 is aligned to become wider than the sector-shaped inspection range 130. FIG. 34 is a graph showing a luminance distribution along the straight line A-A in FIG. 33. The horizontal axis shows a position, and the longitudinal axis shows an amount of light (luminance). As shown, luminance drops in an outer circumference area of pattern illumination (in the vicinity of a boundary), but a range used for actually illuminating the inspection area is set to the central portion inside the portion where the luminance drops.

As described above, the portion where the luminance drops in the outer circumference area of the sector-shaped pattern illumination light has not been used, and defocusing, further, softens an image of the end surface of the fibers bundles, thereby eliminating non-uniformity in luminance due to an image of the fibers bundles showing up. Therefore, the luminance in the sector-shaped inspection area can be uniformed as much as possible.

In addition, as the range of delivery of illumination light becomes wider relative to the inspection area, it is a stricter problem that reflection of undesirable light affects inspection. Accordingly, preferably, the range of delivery of pattern illumination is shaped, and the radiation position is adjusted in a necessary and sufficient range to secure uniformity in luminance. Especially, to minimize undesirable reflection from the claws 16, 17, 18 of the chuck for chucking the central hole of the disk 12 (inner circumference), as shown in FIG. 33, an amount ASI of illumination light extended to the direction of the inner circumference edge is preferably as small as possible. For the purpose, the amount of illumination light extended to the longitudinal direction is preferably made smaller compared to an amount ΔS2 of illumination light extended to the lateral direction of the inspection area and an amount ΔS3 of illumination light extended to the direction of the outer circumference edge (see FIG. 33).

Further, as described with respect to FIG. 15, to mitigate an effect of reflection from texture on the disk surface, generation of scattered light due to the texture is controlled by radiating the texture on the disk surface in the inspection area parallel to the texture with illumination light.

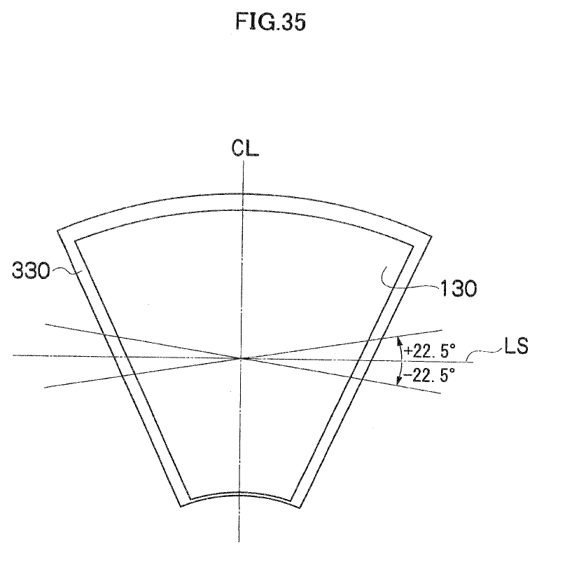

In FIGS. 31 and 32, illumination light is radiated parallel to a line perpendicularly intersecting with the central line which gives left-right symmetry to the sector of the inspection area (from the horizontal direction), but, as shown in FIG. 35, illumination light is radiated in a range of ±22.5° with reference to a line LS perpendicularly intersecting with the central Line CL which gives left-right symmetry to the sector of the inspection area, thereby the optical axis of illumination light always is made somewhere parallel to the texture direction (concentric circle) in the inspection area. Thus, the radiation is appropriately adjusted in the range of ±22.5° relative to the reference line LS.

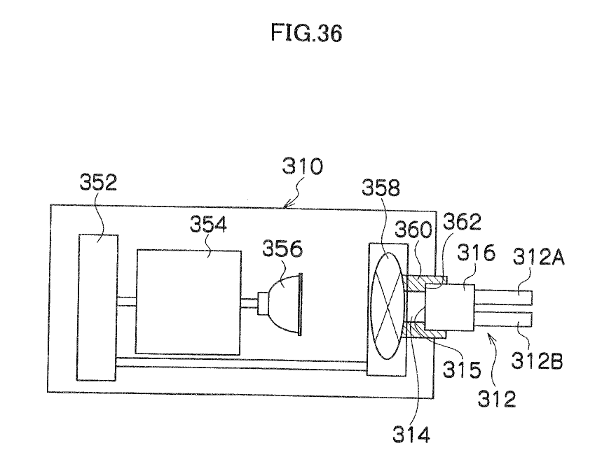

FIG. 36 shows a configuration of a light source apparatus used in the illumination optical system of an embodiment. As shown, a light source apparatus 310 includes a control board 352, a power supply circuit 354, and a metal halide lamp 356, and incorporates a mechanical shutter 358, which can be controlled to open and close by an external input signal.

The end 314 (on the incident side) of the optical fibers cable 312 is connected to the light source apparatus 310 through a fixing member 360. On the fixing member 360, a reference surface 362 for positioning at fixing the optical fibers cable 312 is formed, and a stepped surface 315 of the optical fibers cable 312 is abutted on this reference surface 362 to engage with it, resulting in the optical fibers cable 312 being positioned.

The mechanical shutter 358 is disposed between the metal halide lamp 356 and the incident end surface (light receiving portion) of the optical fibers cable 312, and opening and closing operation thereof can switch between a mode of light entering the optical fibers cable 312 and a mode of light blocked.

The control board 352 includes a control circuit not shown, and receives an external input signal to control the mechanical shutter 358 to open and close, and the power supply circuit 354 to be turned ON (lighting) and OFF (extinction).

As described with respect to the flow chart in FIGS. 25 and 26, illumination of the surface not being inspected that adversely affects inspection can be blocked by making the mechanical shutter 358 of the corresponding light source apparatus 310 open or close in synchronization with timing in which the cameras 102 (first camera) and 104 (second camera) alternately take an image of a surface to be inspected. That is, “ON” and “OFF” of the illumination 1 and the illumination 2 described with respect to the flow chart in FIGS. 25 and 26 are implemented by “opening” and “closing” of the mechanical shutter 358. When the shutter is controlled to open and close while maintaining the metal halide lamp 356 in an “on” state rather than controlling the lamp itself to “ON” and “OFF”, better responsiveness and also better stability in the amount of light are provided.

The illumination optical system of the embodiment can eliminate directly reflected light and high-order reflection of light which constitute disturbance. Also, one light source apparatus 310 is provided for each inspection surface of both surfaces of the disk 12, and illumination light is configured to be radiated from a plurality of directions using the optical fibers cable 312 in the branch form from the one light source apparatus 310, thereby stability in balance of the amount of light can be maintained. Granted that one light source apparatus (lamp) is used for each optical projection portion, the balance may be easily deranged by change in the amount of light of each optical projection portion due to degradation of the lamp and the like. Concerning this point, when branching of one light source apparatus forms a plurality of optical projection portions as in this embodiment, and then the balance can be maintained because light that each optical projection portion of the branched fibers radiates is equally lowered due to degradation of the lamp. Further, non-uniformity in luminance of the illumination light in the inspection range 130 can be regulated and the amount of light can be uniformed.

In addition, in the embodiment described above, the configuration has been illustrated that the illumination Light from one light source apparatus 310, divided into two by the optical fibers cable 312 is radiated from two directions, namely the right and left directions, but there may be an aspect that further many branches are formed from one light source apparatus 310, and one inspection area may be radiated from three or more directions with the illumination light. Also, there may be an aspect that one light source apparatus illuminates both the front face and the back face of the disk 12. In this case, each fibers cable is branched from the one light source apparatus for the front face illumination and the back face illumination.

An inspection process stage of the disk inspection apparatus 100 of the embodiment, for example, is performed before a magnetic transfer process stage for recording servo information on a magnetic disk of a hard disk drive, such as a servo signal for positioning a track, an address information signal of the track, and a reproduction clock signal.

The magnetic transfer process stage executes a method of transfer at a time from a master disk (transfer master disk) in which format information and address information corresponding to a magnetized pattern on the master disk are written, by applying a magnetic field for transfer, with the master disk supporting transfer information formed by a fine, concave and convex pattern of a magnetic substance being brought in close contact with a slave disk (transfer target) having a magnetic recording layer (magnetic layer) for receiving transfer. If dust is attached to a disk, there is a problem that a poor transfer occurs and a scratch and the like are generated on a surface of the master disk.

Therefore, preferably, a slave disk before the transfer processing is inspected for the existence of attachment of dust using the disk inspection apparatus of the embodiment, and when it is confirmed on the inspection that dust is attached to a slave disk, the slave disk is rejected from manufacturing process stages (select only the disk that passes the inspection). Also, a position and size of dust can be identified, so that a narrowed part may be cleaned to be recycled. Further, when cleaning is performed immediately after the inspection, re-inspection can be easily conducted.

In the embodiments described above, the examples have been described that the chuck apparatus of the present invention was used in the inspection process stage, but not limited to the inspection process stage, it may be used in another process stage such as a cleaning process stage of a disk. For example, when the chuck apparatus of the present invention is used in the cleaning process stage, dust can be prevented from attaching and both surfaces of the disk can be easily cleaned because the disk is held in the vertical attitude. In this case, a cleaning method may include, besides an air flow and suction, a wiping method by nonwoven fabric or the like, and a head varnish method using a head.

To be sure, a range to which the present invention applies is not limited to the embodiments described above, and regardless of a type of disk, the present invention may be applicable to various fields.

Also, in the embodiment described above, the system configuration using the computer (PC) (FIG. 16) has been illustrated, but when the present invention is implemented, there may be a form in that a system is controlled, using a microprocessor, by a program for inspection function stored in ROMs (Read Only Memory) or the like.

### [Additional Statement]

The specification also discloses the invention of a chuck apparatus described below suitable as a disk holding device which holds a disk.

### (Invention 1)

A chuck apparatus for holding a disk having a hole formed in its central portion, comprising:

a plurality of claws inserted into the hole formed in the disk to be held, and

a biasing device which biases at least one of the plurality of claws toward the outside of the hole into which the plurality of claws is inserted, wherein

the disk is held in a vertical attitude by applying pressure to an outer circumference portion of the plurality of claws by the biasing device to contact a circumferential edge of the hole of the disk.

According to this invention 1, both surfaces can be inspected simultaneously without the disk being handled (inverted) because the disk is held in the vertical attitude by making the outer circumference portion of the claws contact an inner circumference surface of the disk. In addition, attachment of particle due to the gravity can be also avoided. Further, a down flow of a clean air is not disturbed and cleanliness in the vicinity of the disk can be maintained.

### (Invention 2)

The chuck apparatus according to invention 1, wherein

an outer diameter of a chuck body to which the plurality of claws is mounted is smaller than a hole diameter of the disk.

According to such an aspect, because the chuck body is contained inside the hole of the disk when seen from the direction vertical to a disk surface with the disk being chucked, both surfaces of the disk can be observed (inspected) in the vicinity of the inner circumference edge without any shade.

### (Invention 3)

The chuck apparatus according to invention 1 or 2, wherein

the chuck body to which the plurality of claws is mounted is fixed to a spindle, and can rotate the disk held in the vertical attitude.

According to such an aspect, the entire surface of the disk can be inspected while rotating the disk.

### (Invention 4)

The chuck apparatus according to any one of inventions 1 to 3, wherein

at least one of the plurality of claws is mounted through a movable mechanism which is movable to the inside of the hole into which the plurality of claws is inserted.

In this case, a slide portion of the movable mechanism is preferably disposed at a position away by a distance of (an outer circumference radius—an inner circumference radius) of the disk from the disk held by applying pressure to contact as described above, and more preferably at a position away by a distance not shorter than the outer circumference radius. Accordingly, a particle generated in the slide portion can be prevented from attaching to the disk.

### (Invention 5)

The chuck apparatus according to invention 4, wherein

the slide portion of the movable mechanism is disposed at a position away by a distance not shorter than (the outer circumference radius—the inner circumference radius) of the disk from the disk held by applying pressure to contact as described above.

### (Invention 6)

The chuck apparatus according to any one of inventions 1 to 5, wherein

the biasing device is a passive spring.

As a device which provides chuck biasing force, an aspect is preferable that the chuck body incorporates a passive spring such as a metal spring, a resin spring, an air spring, and a magnetic spring. According to such an aspect, the disk can be held without external force being applied.

### (Invention 7)

The chuck apparatus according to any one of inventions 1 to 6, further comprising:

a claw drive device which moves, against biasing force of the biasing device, at least one of the plurality of claws toward the inside of the hole into which the plurality of claws is inserted, wherein

when the plurality of claws is inserted into the hole, or the pressure applied to contact as described above is released, then the at least one of the plurality of claws is moved to the inside of the hole by the claw drive device.

### (Invention 8)

The chuck apparatus according to invention 7, wherein

the claw drive device is disposed at a position outside and away from the chuck body to which the plurality of claws is mounted.

### (Invention 9)

The chuck apparatus according to any one of inventions 1 to 8, wherein

the claw is made by polybenzimidazole.

Polybenzimidazole has a high abrasion resistance and sliding property, and can control generation of a particle, and also has a low reflectance characteristic without any addition, avoiding an adverse effect on an optical inspection (such as an undesirable image showing up). In addition, polyimide and polyimide-amide also have a high abrasion resistance, but carbon addition is needed to provide sliding property and a low reflectance characteristic, and there are increasing particles.

### (Invention 10)

The chuck apparatus according to any one of inventions 1 to 9, wherein

the claw has an outer circumference portion in an arc shape corresponding to the circumferential edge of the hole of the disk,

the claw dose not contact a flat portion of both surfaces of the disk when holding the disk, and

the claw contacts only the circumferential edge of the hole of the disk to hold the disk.

According to such an aspect, a particle can be prevented from attaching to the disk surface (flat portion), and approximately the entire flat portion can be inspected.

### (Invention 11)

The chuck apparatus according to any one of inventions 1 to 10, wherein

for the plurality of claws, two fixed claws and one movable claw are disposed on the same circumference, and

an angle made between positions of the two fixed claws from the center is smaller than angles made between a position of the movable claw and the positions of the fixed claws from the center.

### (Invention 12)

The chuck apparatus according to invention 11, wherein

when the disk is mounted to the chuck apparatus, or the disk is removed from the chuck apparatus, then the two fixed claws are situated at the same height, and the movable claw is situated below the two fixed claws.

According to such an aspect, stability in holding the disk can be improved, and control of generation of a scratch and a particle due to friction at chucking can be achieved.

What is claimed is:

1. A disk inspection apparatus, comprising:
a disk holding device which holds a disk;
an illumination device which radiates an inspection area portion having a predetermined shape on a disk surface including an edge of the disk held by the disk holding device, with illumination light having an illumination light pattern which forms a range of delivery of illumination light having approximately the same shape as that of the inspection area; and
an imaging device which includes, in the field of view, the inspection area portion on the disk surface including the edge illuminated by the illumination device, and takes an image of light reflected from the inspection area portion.

2. The disk inspection apparatus according to claim 1, wherein
the disk has texture formed on the disk surface, and
the illumination device radiates illumination light along tangential direction of the texture.

3. The disk inspection apparatus according to claim 1, wherein
the illumination device includes a light guide, and
illumination light is radiated from an end surface of the light guide.

4. The disk inspection apparatus according to claim 1, wherein
the illumination device includes a plurality of optical projection portions capable of illuminating the inspection area on the same disk surface, and
the plurality of optical projection portions radiates the disk surface including the edge from a plurality of directions with illumination light.

5. The disk inspection apparatus according to claim 4, wherein
the plurality of optical projection portions symmetrically radiates the disk surface with illumination light.

6. The disk inspection apparatus according to claim 4, wherein
the disk is a circular disk having a hole formed in its central portion, and
the plurality of optical projection portions radiates an edge portion of the disk in the direction along the circumferential direction of the disk with illumination light.

7. The disk inspection apparatus according to claim 1, wherein
the disk is a circular disk having a hole formed in its central portion, and
the inspection area portion has a sector shape including an inner circumference edge and an outer circumference edge.

8. The disk inspection apparatus according to claim 1, wherein
the disk holding device includes a disk rotation device which rotates the disk held, and
rotating the disk by the disk rotation device allows the disk surface at a different position to be inspected.

9. The disk inspection apparatus according to claim 1, wherein
the disk holding device holds the disk in a vertical attitude.

10. The disk inspection apparatus according to claim 1, further comprising:
as the illumination device,
a first illumination device which radiates an inspection area portion in a predetermined shape, including an edge of a first surface, namely one surface of the disk held by the disk holding device, with illumination light having an illumination light pattern which forms a range of delivery of illumination light having approximately the same shape as that of the inspection area, and
a second illumination device which radiates an inspection area portion in a predetermined shape, including an edge of a second surface, namely the other surface of the disk held by the disk holding device, with illumination light having an illumination light pattern which forms a range of delivery of illumination light having approximately the same shape as that of the inspection area are provided; and
as the imaging device,
a first imaging device which includes, in the field of view, the inspection area portion on the first surface illuminated by the first illumination device, and takes an image of light reflected from the inspection area portion, and
a second imaging device which includes, in the field of view, the inspection area portion on the second surface illuminated by the second illumination device, and takes an image of light reflected from the inspection area portion.

11. The disk inspection apparatus according to claim 8, further comprising:
as the illumination device,
a first illumination device which radiates an inspection area portion in a predetermined shape, including an edge of a first surface, namely one surface of the disk held by the disk holding device, with illumination light having an illumination light pattern which forms a range of delivery of illumination light having approximately the same shape as that of the inspection area, and
a second illumination device which radiates an inspection area portion in a predetermined shape, including an edge of a second surface, namely the other surface of the disk held by the disk holding device, with illumination light having an illumination light pattern which forms a range of delivery of illumination light having approximately the same shape as that of the inspection area are provided;
as the imaging device,
a first imaging device which includes, in the field of view, the inspection area portion on the first surface illuminated by the first illumination device, and takes an image of light reflected from the inspection area portion, and
a second imaging device which includes, in the field of view, the inspection area portion on the second surface illuminated by the second illumination device, and takes an image of light reflected from the inspection area portion; and
a control device which controls to obtain an inspection image of the entire both surfaces of one disk by taking images a plurality of times using the first and second imaging devices while a position of the disk to be inspected is changed by rotation by the disk rotation device.

12. The disk inspection apparatus according to claim 10, wherein
taking an image by the first imaging device and taking an image by the second imaging device are alternately carried out.

13. The disk inspection apparatus according to claim 1, wherein
the disk is a magnetic disk having a magnetic layer for magnetic recording.

14. The disk inspection apparatus according to claim 1, further comprising:
an image processing device which detects a plurality of edge points of the disk from an image taken by the imaging device, computes a central position and a radius of the disk, and automatically creates a window for each inspection surface based on the computation result.

15. The disk inspection apparatus according to claim 1, further comprising:
an image analysis device which recognizes a reflection shape of the edge portion of the disk from an image taken by the imaging device, and distinguishes between a reflection shape due to dust and a reflection shape due to factors except the dust based on the reflection shape.

16. The disk inspection apparatus according to claim 1, further comprising:
a dust detection processing device which detects dust attached to a flat portion of the disk and dust attached to the edge portion of the disk from an image taken by the imaging device.

17. The disk inspection apparatus according to claim 1, wherein
an incident angle of illumination light with which the illumination device radiates the disk surface is not smaller than 60° and smaller than 90°.

18. The disk inspection apparatus according to claim 1, wherein
the illumination device is configured by bundling optical fibers,
a lens is disposed on an exit end of the optical fibers, and
the disk surface is radiated with defocused light.

19. The disk inspection apparatus according to claim 12, wherein
when an image is alternately taken to inspect, illumination on the side not to be inspected is extinguished or blocked.

20. A method for inspecting a disk, comprising the steps of:
illuminating, after holding a disk to be inspected, an inspection area portion having a predetermined shape on a disk surface including an edge of the disk held, with illumination light having an illumination light pattern which forms a range of delivery of illumination light having approximately the same shape as that of the inspection area;
taking an image of light reflected from the inspection area portion by an imaging device which includes, in the field of view, the inspection area portion on the disk surface including the edge illuminated by the step of illuminating; and
analyzing an image taken by the step of taking an image.
